(19) United States
(12) Patent Application Publication
(10) Pub. No.: US 2026/0079623 A1
(43) Pub. Date: Mar. 19, 2026

(54) SYSTEM AND METHOD FOR CONFIGURABLE HARDWARE ARCHITECTURE FOR READ OPERATIONS OF A FLASH MEMORY

(71) Applicant: Kioxia Corporation, Tokyo (JP)

(72) Inventors: Ofir Kanter, Tel Aviv (IL); Avi Steiner, Tel Aviv (IL); Amir Nassie, Tel Aviv (IL); Gil Grau, Tel Aviv (IL); Eyal Nitzan, Tel Aviv (IL); Nimrod Bregman, Tel Aviv (IL); Hanan Weingarten, Tel Aviv (IL)

(73) Assignee: Kioxia Corporation, Tokyo (JP)

(21) Appl. No.: 18/921,321

(22) Filed: Oct. 21, 2024

Related U.S. Application Data
(60) Provisional application No. 63/695,132, filed on Sep. 16, 2024.
(60) Provisional application No. 63/695,114, filed on Sep. 16, 2024.

(51) Int. Cl. G06F 3/06

(52) U.S. Cl. CPC G06F 3/0613; G06F 3/064; G06F 3/0659; G06F 3/0679

(57) ABSTRACT

In some embodiments, a flash memory system may include a non-volatile memory, a controller, a first processor, and a second processor. The first processor may generate a first configuration including a pointer to a first set of predefined configurations among a plurality of predefined configurations. In response to generating the first configuration, the circuit may generate, in a memory, the first set of predefined configurations. The controller may execute a first operation according to the first set of predefined configurations generated in the memory. The second processor may generate a second configuration comprising a pointer to a second set of predefined configurations among the plurality of predefined configurations. In response to generating the second configuration, the controller may generate, in the memory, the second set of predefined configurations. The controller may execute a second operation according to the second set of predefined configurations generated in the memory.

### CROSS-REFERENCE TO RELATED APPLICATIONS

This application claims the benefit of and priority to U.S. Provisional Patent Application No. 63/695,132 filed on Sep. 16, 2024 and U.S. Provisional Patent Application No. 63/695,114 filed on Sep. 16, 2024, both of which are incorporated herein by reference in its entirety for all purposes.

### TECHNICAL FIELD

The present embodiments relate generally to system and method for performing operations of a flash memory, and more particularly to system and method for providing configurable hardware blocks to perform read operations of a flash memory.

### BACKGROUND

As the number and types of computing devices continue to expand, so does the demand for memory used by such devices. Memory includes volatile memory (e.g. RAM) and non-volatile memory. One popular type of non-volatile memory is flash memory or NAND-type flash. A NAND flash memory array includes rows and columns (strings) of cells. A cell may include a transistor.

Due to different stress conditions (e.g., NAND noise and interference sources) during programming and/or read of the NAND flash memory, there may be errors in the programmed and read output. Improvements in decoding capabilities in such a wide span of stress conditions for NAND flash devices remain desired.

### SUMMARY

The present embodiments relate to system and method for providing configurable hardware blocks to perform read operations of a flash memory.

According to certain aspects, embodiments provide a method for performing operations on a non-volatile memory including one or more blocks, each block including a plurality of rows of cells. The method may include generating, by a first processor, a first configuration including a pointer to a first set of predefined configurations among a plurality of predefined configurations for performing read operations on the non-volatile memory. The method may include in response to generating the first configuration, generating, in a memory, the first set of predefined configurations. The method may include executing, by a controller, a first operation according to the first set of predefined configurations generated in the memory. The method may include generating, by a second processor, a second configuration including a pointer to a second set of predefined configurations among the plurality of predefined configurations. The method may include in response to generating the second configuration, generating, in the memory, the second set of predefined configurations. The method may include executing, by the controller, a second operation according to the second set of predefined configurations generated in the memory.

According to other aspects, embodiments provide a flash memory system including a non-volatile memory, a controller for performing operations on the non-volatile memory, and a plurality of processors including a first processor and a second processor. The non-volatile memory may include one or more blocks, each block comprising a plurality of rows of cells. The first processor may generate a first configuration including a pointer to a first set of predefined configurations among a plurality of predefined configurations for performing read operations on the non-volatile memory. In response to generating the first configuration, the controller may generate, in a memory, the first set of predefined configurations. The controller may execute a first operation according to the first set of predefined configurations generated in the memory. The second processor may generate a second configuration comprising a pointer to a second set of predefined configurations among the plurality of predefined configurations. In response to generating the second configuration, the controller may generate, in the memory, the second set of predefined configurations. The controller may execute a second operation according to the second set of predefined configurations generated in the memory.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 illustrates an example of a voltage threshold distribution according to some embodiments;

FIG. 2 illustrates an example process of read flow in a conventional flash device;

FIG. 3 illustrates an example of a fully-connected (FC) deep neural network (DNN) for a row-to-row (R2R) estimator according to some embodiments;

FIG. 4 illustrates an example of read flow that employs an R2R estimator for all stages in the read flow according to some embodiments;

FIG. 5 is a diagram illustrating an example static random access memory (SRAM) structure, according to some embodiments;

FIG. 6 is a diagram illustrating an example codebook database, according to some embodiments;

FIG. 7 is a diagram illustrating an example row-to-row (R2R)-look-up table (LUT) database, according to some embodiments;

FIG. 8 is a diagram illustrating an example weights coefficient matrix, according to some embodiments;

FIG. 9 is a diagram illustrating an example of DNN parameters placement in memory, according to some embodiments;

FIG. 10 is a diagram illustrating an example scheme of register file (regfile) configuration sets, according to some embodiments;

FIG. 11 is a diagram illustrating an example fully-connected (FC) DNN, according to some embodiments;

FIG. 12 is a diagram illustrating an example entity embedding scheme, according to some embodiments;

FIG. 13 is a diagram illustrating an example of fixed-point calculation of a neuron in a layer, according to some embodiments;

FIG. 14 is a diagram illustrating an example architecture of fixed-point calculation scheme, according to some embodiments;

FIG. 15 is a diagram illustrating an example DNN computation scheme, according to some embodiments;

FIG. 16 is a diagram illustrating example DNN engine main interfaces, according to some embodiments;

FIG. 17 is a diagram illustrating example R2R engine main interfaces, according to some embodiments;

FIG. 18 is a diagram illustrating an example instance of per-threshold calculation building block, according to some embodiments;

FIG. 19 is a diagram illustrating an example of iterative K-means search based on ×3 instances of per-threshold calculation building block, according to some embodiments;

FIG. 20 is a diagram illustrating an example of K-means search engine main interfaces, according to some embodiments;

FIG. 21 is a diagram illustrating an example of a top-level architecture of read operation hardware, according to some embodiments;

FIG. 22 is a diagram illustrating an example scheme of loading mem-regfile, according to some embodiments;

FIG. 23 is a diagram illustrating an example output mapping logic, according to some embodiments;

FIG. 24 is a diagram illustrating an example of clipping and DC offset adjustment, according to some embodiments;

FIG. 25 is a diagram illustrating an example system of pipeline hardware operating with multiple CPUs, according to some embodiments;

FIG. 26 is a diagram illustrating an example hardware implementations for HT-GET-DNN for a first-phase read operation, according to some embodiments;

FIG. 27 is a diagram illustrating an example hardware implementations for HT-GET-DNN using HT-codebook (CB) index with R2R DNN for target row thresholds estimation, according to some embodiments;

FIG. 28 is a diagram illustrating an example hardware implementations for HT-GET-LUT using HT-CB index with R2R look-up table (LUT), for target row thresholds estimation, according to some embodiments;

FIG. 29 is a diagram illustrating an example hardware implementations for general DNN operations, according to some embodiments;

FIG. 30 is a diagram illustrating an example hardware implementations for R2R target-row to reference-row thresholds estimation using LUT, according to some embodiments;

FIG. 31 is a diagram illustrating an example hardware implementations for R2R reference-row to target-Row thresholds estimation using LUT, according to some embodiments;

FIG. 32 is a diagram illustrating an example hardware implementations for HT-Set using a K-means search for computing a CB-index given input thresholds, according to some embodiments;

FIG. 33 is a block diagram illustrating an example flash memory system according to some arrangements.

FIG. 34 is a flowchart illustrating an example methodology for providing configurable hardware blocks to perform read operations of a flash memory, according to some embodiments.

### DETAILED DESCRIPTION

According to certain aspects, embodiments in the present disclosure relate to techniques for providing configurable hardware blocks to perform read operations of a flash memory.

In a conventional flash memory system (e.g., controller in NAND flash devices) may implement simplified read flows where fixed thresholds are used at start-of-life (SOL). These thresholds are called default thresholds, or first-phase-read thresholds, or normal read thresholds. In case of failure, a read retry may be performed with predetermined thresholds from a look-up table (LUT). If the retry succeeds, these thresholds can be used for all other reads from the same block. This simple and straightforward approach is limited and generally implemented in firmware (FW) without degradation in system read performance. However, when more complex read flows are introduced, there is a risk of performance degradation. This is due to the increased latency associated with executing more sophisticated algorithms, which may be required to optimize read thresholds on a per-command basis, potentially impacting overall system read performance.

To solve these problems, according to certain aspects, embodiments in the present disclosure relate to systems and methods for improving performance of read operations with a configurable hardware architecture for read operations (e.g., read digital signal processor hardware (RDSP-HW) operations) in a NAND flash memory. In some embodiments, a flash memory system (e.g., a NAND flash device) can provide a generic block that enables RDSP operations in controllers of NAND flash devices. In some embodiments, the flash memory system (“the system”) can dynamically adapt read thresholds during a read flow on a per-row, per-stress basis, replacing traditional fixed default thresholds.

In some embodiments, the system can provide a RDSP-HW architecture, which allows for per-row optimized thresholds to be computed and applied in real-time, without any degradation in read performance. In the event of a read failure, the system can calculate estimated optimized read thresholds for the failed row, which are used to re-read the failed row. In some embodiments, the system can search over a quantized database that has been prepared offline, to identify an index that serves as a compressed version of read thresholds of a reference row. In some embodiments, the system can save or store this index for future read commands from different rows within the same block.

In some embodiments, the system can provide one or more RDSP-HW blocks that perform read operations (e.g., estimation of optimized read thresholds, identification and saving of a compressed version of read thresholds, etc.) with minimal latency and high throughput, thereby ensuring that performance requirements are met.

In some embodiments, the system can provide a centralized focal point block within the system, that encapsulates and/or implements one or more RDSP algorithms for managing read flow operations and read-retry flow operations. The one or more RDSP algorithms can include, for example, row-to-row (R2R) estimation of optimized read thresholds, estimation of optimized read thresholds using a machine learning model (e.g., DNN), quick threshold tracking (QT), K-means search for a compressed version of read thresholds, etc.

In some embodiments, the system can provide a hardware acceleration that enables running complex RDSP operations in a short latency. The system can provide a higher accuracy of read thresholds compared to conventional algorithms that are implemented in firmware, and thus can reduce a read retry rate (RRR), with no impact on read flow performance (e.g., performance measured in input/output operations per second (IOPS) or throughput) during start of life (SOL).

In some embodiments, the system can provide a reusable architecture (e.g., RDSP-HW) that can reuse the same or shared engines (e.g., circuits, firmware, software, or a combination thereof) for different RDSP algorithms (e.g., R2R, DNN, QT, K-means search). The same or shared engines can reduce a gate count and power consumption of a flash memory system.

In some embodiments, the system can provide a highly configurable architecture (e.g., RDSP-HW) that enables different flows and/or parameters using different register files (“regfiles”) to effectively support current and future flash devices with adapted algorithms and/or parameters. In some embodiments, the system can enable multiple processors (e.g., CPUs) to access to a read operation block (e.g., RDSP-HW block) simultaneously. Each CPU can perceive or use the read operation block as a distinct virtual machine, possessing a dedicated register file configuration space (e.g., per-CPU regfile in memory). The system can provide a highly configurable architecture designed to synchronize and manage tasks originating from different CPUs. This architecture can allow multiple CPUs to interact with the same read operation block in an orthogonal manner, thereby eliminating the need to replicate such read operation block for each CPU.

In some embodiments, the system can provide a hardware architecture for fast configuration and reading statuses that can perform read operations (e.g., RDSP operations) with no performance degradation on a read flow during SOL. The system can achieve high read performance due to reduced probability of read failure by adapting read thresholds for SOL conditions, even before a first retry with no performance degradation. This can be achieved by a row-to-row (R2R) estimator which is used during first-phase reads to replace the conventional default reads.

In some embodiments, the system can provide a single generic DNN hardware engine (e.g., DNN engine) that can be used for different algorithms using different parameters (e.g., R2R, QT). For example, for a R2R estimation, a DNN engine can receive, as input, stress conditions and a target row, and compute, as output, target thresholds to be used for a target row under current stress conditions. In this manner, the system can achieve high read performance and allow real-time estimation of target page-read thresholds for every read operation. For a QT operation, the DNN engine can receive, as input, stress conditions and histograms of few mock reads with fixed thresholds row, and compute, as output, estimated optimal read thresholds of the current row. The estimated thresholds can be configured to NAND for read retry.

According to certain aspects, embodiments in the present disclosure relate to a method for performing operations on a non-volatile memory including one or more blocks, each block including a plurality of rows of cells. The method may include generating, by a first processor, a first configuration including a pointer to a first set of predefined configurations among a plurality of predefined configurations for performing read operations on the non-volatile memory.

The method may include in response to generating the first configuration, generating, in a memory, the first set of predefined configurations. The method may include executing, by a controller, a first operation according to the first set of predefined configurations generated in the memory. The method may include generating, by a second processor, a second configuration including a pointer to a second set of predefined configurations among the plurality of predefined configurations. The method may include in response to generating the second configuration, generating, in the memory, the second set of predefined configurations. The method may include executing, by the controller, a second operation according to the second set of predefined configurations generated in the memory.

According to certain aspects, embodiments in the present disclosure relate to a flash memory system including a non-volatile memory, a controller for performing operations on the non-volatile memory, and a plurality of processors including a first processor and a second processor. The non-volatile memory may include one or more blocks, each block comprising a plurality of rows of cells. The first processor may generate a first configuration including a pointer to a first set of predefined configurations among a plurality of predefined configurations for performing read operations on the non-volatile memory. In response to generating the first configuration, the controller may generate, in a memory, the first set of predefined configurations. The controller may execute a first operation according to the first set of predefined configurations generated in the memory. The second processor may generate a second configuration comprising a pointer to a second set of predefined configurations among the plurality of predefined configurations. In response to generating the second configuration, the controller may generate, in the memory, the second set of predefined configurations. The controller may execute a second operation according to the second set of predefined configurations generated in the memory.

Embodiments in the present disclosure have at least the following advantages and benefits. First, embodiments in the present disclosure can provide a highly configurable architecture that enables different flows/parameters to support effectively current and future flash devices with adapted algorithms/parameters. For example, the system can enable fast configuration by copying a configuration set from static random access memory (SRAM) to a register file in a memory (e.g., mem-regfile), thereby being faster than the traditional advanced peripheral bus (APB) configuration, and reducing a CPU configuration time. The system can achieve area saving because the configurable architecture uses only a single mem-regfile instantiation rather than duplicating in per-CPU regfile for each CPU. The system also can minimize APB traffic, since only a pointer is configured over APB, and the hardware copies the configurations from SRAM to mem-regfile, without loading the APB bus.

Second, embodiments in the present disclosure can provide hardware acceleration that enables running complex RDSP operations in short latency, providing a higher accuracy of read thresholds compared to simple algorithms that are implemented in firmware, and thus the system can reduce an RRR with no impact on read flow performance. The system can provide methods for fast configuration and reading statuses, thereby helping to perform read operations with no performance degradation on read-flow during start-of-life (SOL). The system can achieve high read performance due to reduced probability of read failure by adapting read thresholds for SOL conditions, even before a first retry with no performance degradation. This can be achieved by a row-to-row (R2R) estimator which is used during first-phase reads to replace the conventional default reads.

Third, embodiments in the present disclosure can provide a reusable architecture to reuse the same or shared engines (e.g., hardware, firmware, software, or a combination thereof) for different RDSP algorithms so that shared hardware engine can reduce a gate count and power consumption of a flash memory system. For example, a single generic DNN hardware can be used for different algorithms using different parameters (e.g., R2R-DNN, QT, K-means search)

Fourth, embodiments in the present disclosure can provide an architecture that enables multiple CPUs to access to a read operation block (e.g., RDSP-HW block) simultaneously. Each CPU can use and/or perceive the read operation block as a distinct virtual machine, possessing a dedicated register file configuration space (e.g., per-CPU regfile in memory). The system can synchronize and manage tasks originating from different CPUs, and allow multiple CPUs to interact with the same read operation block in an orthogonal manner, thereby eliminating the need to replicate such read operation block for each CPU. The system can enable multiple CPUs to access the read operation block or unit (e.g., RDSP-HW unit) for configuration, read status, or polling simultaneously. This architecture can enable multiple CPUs to access a single RDSP-HW unit. Thus, the architecture also can reduce area, because there is a single RDSP-HW units that works with multiple CPUs, rather than a dedicated RDSP-HW unit per CPU. This architectures can configure (over APB) only a pointer to SRAM (instead of configuring a full configuration), thereby minimizing the APB traffic. The RDSP-HW logic can fetch a pre-defined configuration in SRAM according to the pointer and copy the pre-defined configuration in SRAM to a mem-regfile.

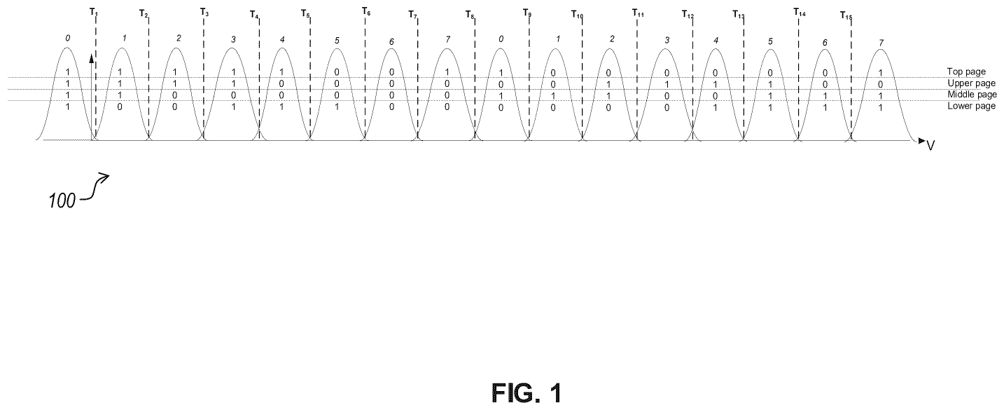

Referring to FIGS. 1-34, embodiments of systems and methods for the present solution to dynamically adapt read thresholds based on per row optimal thresholds characterization are described and illustrated.

FIG. 1 illustrates an example of a voltage threshold distribution 100 according to some embodiments. FIG. 1 illustrates a voltage threshold distribution of 4 bits per cell (bpc) flash memory device, i.e., quadruple level cells (QLC) with 16 programmable states. The voltage threshold (VT) distribution includes 16 lobes. A lower page read requires using thresholds T1, T3, T6 and T12. For reading the middle page, the read thresholds T2, T8, T11 and T13 are used. For reading the upper page, the read thresholds T4, T10 and T14 are used. For reading the top page, thresholds T5, T7, T9 and T15 are used. The lower most lobe (0) is known as the erase level. Retention, program/erase cycles and read disturb can change the voltage threshold distribution (E.g., voltage threshold distribution shown in FIG. 1) in different ways and create various bit error rate (BER) conditions. For each condition, different read thresholds can be chosen for achieving lowest BER after READ operation. Thus, the read thresholds of a target page in a NAND device are estimated repeatedly during the device life cycle in order to maintain high read performance and benefit from an efficient read flow with low latency that avoids SB decoding (soft-bit decoding) as much as possible.

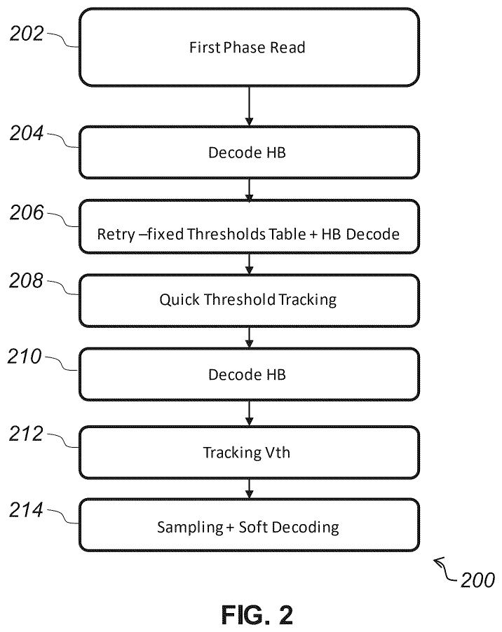

FIG. 2 illustrates an example (simplified) process of read flow in a conventional flash device. FIG. 2 describes typical stages for read-retry in case of failures. By default, a flash memory system (e.g., controllers of a NAND flash device) may perform first-phase reads, which refers to reads with pre-configured (or pre-defined) initial default thresholds (step 202). In some embodiments, read operations (e.g., read digital system processor) and error correction code (ECC) operations can be implemented in a controller of a NAND flash device.

The system (e.g., a controller of a NAND flash device) may decode a read by a hard-bit (HB) decoder, e.g., a decoder that operates on binary input (step 204). In case of a decode failure, the controller may refer to a shift table that holds several thresholds candidates. The candidate thresholds are also referred to as a “retry-fixed thresholds table”. On a first (read) failure on a page, the controller may choose or select a first table entry, configure the NAND thresholds based on the first entry, read the same page again, and perform HB decoding (step 206). In case of a second failure, the process may be repeated with other shift table candidates until success on HB decoding. On a HB decode success, the shift table entry (e.g., a threshold candidate used for the read corresponding to the HB decode success) may be saved in a table called history table (HT) that is available per block. A pointer to the HT may be used for future reoccurring reads from same block, to allow the controller to use the same thresholds that are compatible to a current stress of this block. If decoding fails with all shift table candidates, then the controller may perform a quick threshold tracking (QT) to estimate the optimal thresholds of the current row (step 208). The QT may perform a few mock reads with fixed thresholds, from which a histogram is computed. An estimator (e.g., controller, or software, firmware, hardware, or a combination thereof) may use the histogram for estimating the current thresholds. The estimator can be a linear estimator or a DNN based estimator. The controller may configure estimated thresholds to NAND, and perform a read-retry, followed by HB decoding (step 210). If HB decoding fails, then the controller may perform a higher complexity threshold tracking (step 212), e.g. pre-soft tracking (PST), followed by sampling and/or soft decoding (step 214).

In some embodiments of the present disclosure, a system (e.g., a NAND flash device or a controller thereof) can perform a row-to-row (R2R) estimation. According to the physical characteristics of the NAND, there is a typical voltage-threshold (VT) probability distribution for every NAND row per block. On 3D-NANDs there may be a typical distribution per word-line (WL), where rows within a given WL may have a similar VT distribution (referred to as a row-VT distribution). Therefore, if thresholds are known for a target row as a result of activating an estimation process on that row, then it might be useful to use this result and estimate thresholds of any other row, from a given row (e.g., the target row) and thresholds of the given row, by using the typical row-VT distribution, thereby saving the cost and/or overhead of thresholds-estimation per row.

According to some embodiments of the present disclosure, a row-to-row (R2R) estimator can be trained in order to provide a minimized retry probability, when a controller performs first-phase reads. The R2R estimator can receive as input a target row, and provide optimal shifts (e.g., optimal in terms of reducing a retry probability) to apply with respect to a first-phase read shift. In some embodiments, the first-phase read shift may be zero shifts of default thresholds. The R2R estimator can be implemented in various manners including (1) a look-up-table (LUT), which provides the shifts per threshold and per row; (2) a linear based estimator; and/or (3) a DNN based estimator. In some embodiments, a LUT-based R2R estimator for first-phase reads may be fully optimized to support all required stresses to provide lowest RRR with first-phase-reads using a LUT (e.g., a LUT which provides the shifts per threshold and per row). As a NAND density increases, the blocks may become larger, due to having more layers and strings per block. The advantage of using a DNN-based R2R estimator is relatively smaller memory requirements for such large blocks. Thus, a DNN-based R2R estimator can perform effectively a compression of a LUT. Such DNN-based compression is also scalable to future NAND devices.

As another embodiment of the present disclosure, an R2R estimator can be trained for a fixed thresholds set, which are used within a read retry flow (or a read retry process/operation). That is, the R2R estimator can have a specific trained configuration for every entry of a retry-fixed thresholds table, where each entry represents another subset of stress conditions that are supported by the controller. For example, in case of data-retention (DR) stress, thresholds can be optimized over a specific row that is referred to as “reference row”. A table (e.g., LUT for R2R) can be optimized on this stress as well, to convert the reference row thresholds to every other row under this DR stress.

In some embodiments, the R2R estimator can be described more formally as

$${TH}_{r 2 r} ( row , ShiftIdx ) = {TH}_{ref} ( ShiftIdx ) + {LUT}_{ShiftIdx} ( row ) \qquad ( Equation 1 )$$

For every shift index, a LUT can be defined per row to provide target thresholds. A shift index may be a retry-fixed thresholds table index which is an index to a retry-fixed thresholds table. An “index” or “shift index” refers to a retry pointer that is saved per block. The retry pointer can be associated with a stress condition. Holding a LUT per shift-index means that there is a different R2R estimator per read-retry. The row index can be an entry pointer to the LUT. This can adapt the R2R estimation according to a stress condition. In some embodiments, first-phase reads may correspond to ShiftIdx=0. This LUT-based implementation may be memory inefficient. In a LUT implementation, a suboptimal solution which saves memory can use a common LUT for all shift indexes, as follows:

$${TH}_{r 2 r} ( row , ShiftIdx ) = {TH}_{ref} ( ShiftIdx ) + LUT ( row ) \qquad ( Equation 2 )$$

where an identical LUT can be used for all shift indices. The LUT can also be the same table for the case of read after quick threshold tracking (QT). The reference thresholds in the case of read after QT may be mapped from a failed row to a (common) reference row using the LUT, and then the thresholds value may be compressed by clustering to the nearest cluster (e.g., using K-means clustering), and only the index cluster center can be saved as the ShiftIdx. This compression can significantly reduce the memory requirements per threshold tracking operation, allow for using a compact history table (HT) to save the state of a block after failure, and/or allow near optimal thresholds for all rows using the R2R estimator with the mapped ShiftIdx after QT.

As another embodiment of the present disclosure, the R2R estimator can be implemented by a DNN, which may receive the ShiftIdx as an input feature, together with a row index (e.g., row index of a target row), and provide the thresholds to be used for read of the target row. The ShiftIdx can be available from the history table per block.

$${TH}_{r 2 r} ( row ) = DNN ( ShiftIdx , row ) \qquad ( Equation 3 )$$

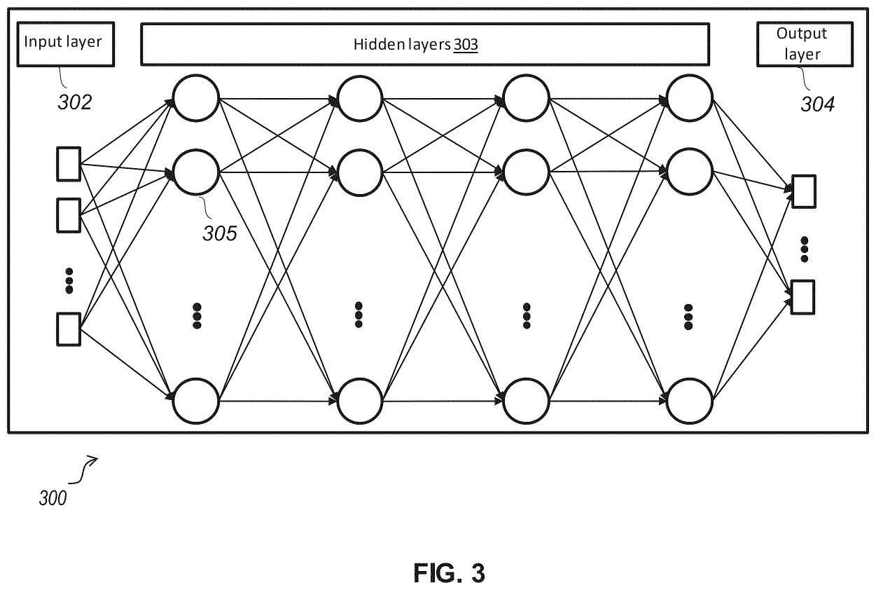

FIG. 3 illustrates an example of a fully-connected (FC) deep neural network (DNN) 300 for a row-to-row (R2R) estimator according to some embodiments. The example DNN may include an input layer 302, one or more hidden layers 303, and/or an output layer 304. In the example DNN shown in FIG. 3, the input layer 302 can include a target row index (e.g., index to a target row) and a shift index. The output layer 304 can include an estimated thresholds for the target row.

In some embodiments of the present disclosure, a row index can be represented by entity embedding (EE) which is a result of a 1-hot input training for a DNN estimator (e.g., DNN-based R2R estimator). In some embodiments, entity embedding for the row index can be implemented or obtained by training a 1-hot input of row index that is fully connected to a few neurons of a DNN(e.g., neurons 305). The entity embedding values per row can be saved in a LUT which is used as input instead of a 1-hot input. For example, the LUT can map a row index to values of neurons that are connected to the original 1-hot input. The LUT can be used to provide the neuron values per row index instead of the 1-hot input and the neuron's fully connect weights. This can save a lot of memory, and can reduce implementation complexity. This LUT-based implementation of the entity embedding (EE) is very robust for large NAND blocks with many rows. Since the entity embedding (EE) implementation saves memory and reduces implementation complexity, the EE can be used for large NAND blocks. The EE can be an alternative form for implementing row index encoding to neuron values.

As another embodiment of the present disclosure, a DNN (or a DNN-based R2R estimator) can be trained with input thresholds which correspond to (1) optimal thresholds of a selected reference row, or (2) QT thresholds of the selected reference row. In some embodiments, the R2R thresholds obtained by the DNN-based R2R estimator can be given by

$${TH}_{r 2 r} ( row ) = DNN ( ( ShiftIdx , row , {TH}_{HT - ref} ) \qquad ( Equation 4 )$$

where the ShiftIdx (shift index) can be a pointer to the phase/retry stages of the history table. The shift index can correspond to the number of retry or the current stress condition (e.g., retry index). This retry index can be a subset of a history table (HT). The HT can be a generalized form of saving thresholds per block corresponding to different stress conditions. The ShiftIdx can be a pointer to the generalized HT. Initial few entries (e.g., low index values) of the HT can correspond to a few ordered start-of-life (SOL) set of stresses, hence the shift-index can be used as input to the DNN. The TH_{HT-ref} input can correspond to the thresholds extracted from the history table, in case that QT is activated on this block. The TH_{HT-ref} input can be reference thresholds from HT that are closest to the estimated thresholds by a QT operation while TH_{HT-ref} is read-flow dependent.

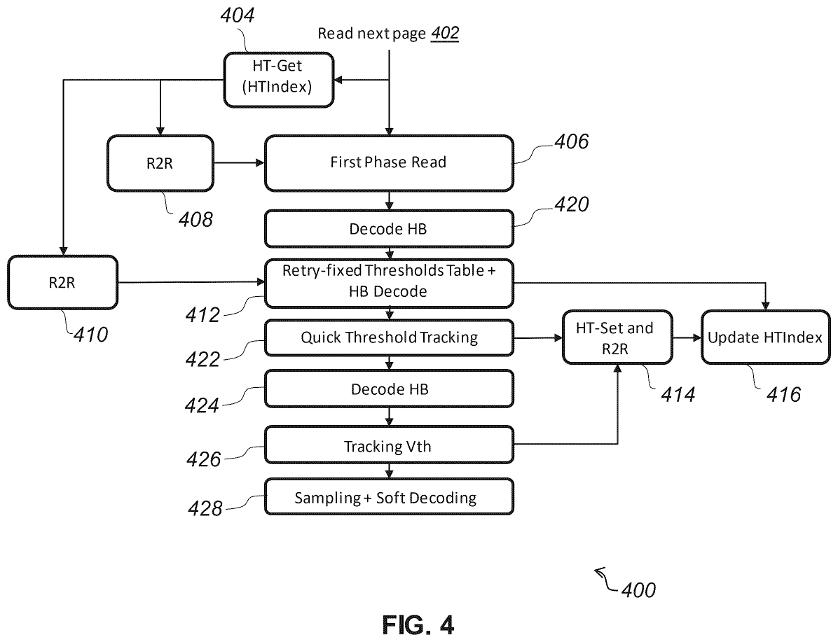

FIG. 4 illustrates an example of read flow 400 that employs an R2R estimator for all stages in the read flow according to some embodiments. FIG. 4 demonstrates a read-flow which employs a R2R transformation on input thresholds, according to a read stage. The R2R thresholds can be taken or obtained from a R2R estimator according to some embodiments of the present disclosure. FIG. 4 depicts an exemplary read-flow that includes row-to-row (R2R) estimation within the normal reads and shift retries. FIG. 4 also depicts a case of read-retry flow. The read flow shown in FIG. 4 includes receiving and/or executing a read command to a target page (step 402). A history table (HT)-Get operation can extract a HTIndex (e.g., index to a history table) that keeps the state of the block and points to the type of read on a first stage (e.g., first phase read) (step 404). By default, a flash memory system (e.g., one or more controllers of a NAND flash device) can perform a first-phase read (step 406), which refers to reads with pre-configured initial default thresholds. The system can also apply a R2R estimator (step 408) to adapt to target row. In some embodiments, all the read operations (e.g., RDSP operations) and error correction code (ECC) operations can be implemented in the one or more controllers. The read can be decoded by a hard-bit (HB) decoder, e.g., a decoder that operates on binary input (step 420). In case of a decode-fail, the controller can refer to a “shift table” that holds several thresholds candidates. On a first failure, the controller can choose a first table entry of the shift table and configure the NAND thresholds, jointly with a R2R estimator adaptation (step 410) to a target row. The controller can read the same page again, and perform HB decoding (step 412). In case of a second failure, the controller can repeat the process with other shift table candidates and R2R estimator(s) until success on HB decoding. On HB decode success, the corresponding shift table entry can be saved in a table called history table (HT) that is available per block (step 414). A pointer to the HT can be used for future reoccurring reads from same block (step 416), to allow the controller to use the same thresholds that are compatible to current stress of this block.

In some embodiments, if decoding fails with all shift table candidates, then the controller can perform quick threshold tracking (QT) (step 422) to estimate the optimal thresholds of the current row. In some embodiments, the QT can perform a few mock reads with fixed thresholds, from which a histogram is computed. The histogram can be used for estimating the current optimal read-thresholds. In some embodiments, a threshold estimator can be a linear estimator or a DNN based estimator. The current estimated thresholds can be configured to NAND for a retry read and HB decode. A R2R operation (e.g., LUT-based R2R operation or DNN-based R2R operation) can transfer the current estimated threshold to reference row thresholds, and the reference row thresholds can be used for updating the HT table. In some embodiments, a flash memory system (e.g., controller) can perform a HT-Set operation (step 414) that compresses the thresholds into an index pointer (e.g., HTindex) for the HT table. The HTindex can point to HT thresholds that are closest to the estimated read thresholds, and can be used for subsequent reads from the same block (step 416). If HB decoding fails after QT (step 424), then a higher complexity threshold tracking is performed (step 426), e.g. pre-soft tracking (PST), followed by soft decoding (step 4128).

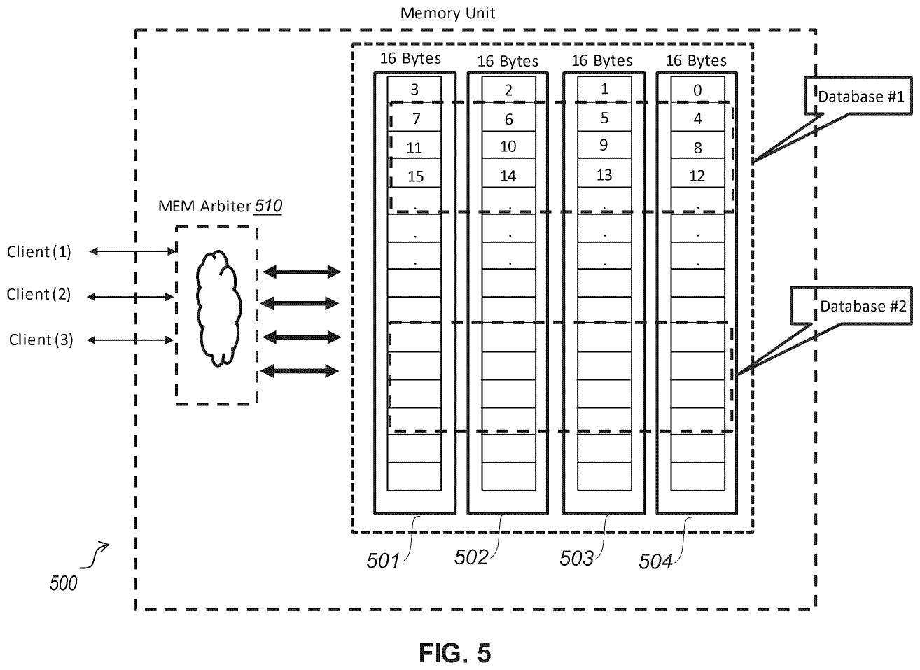

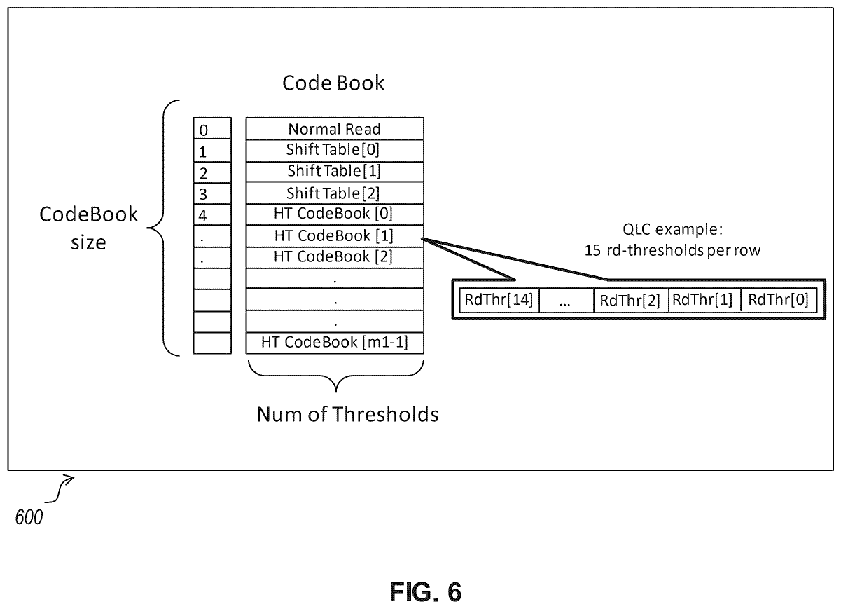

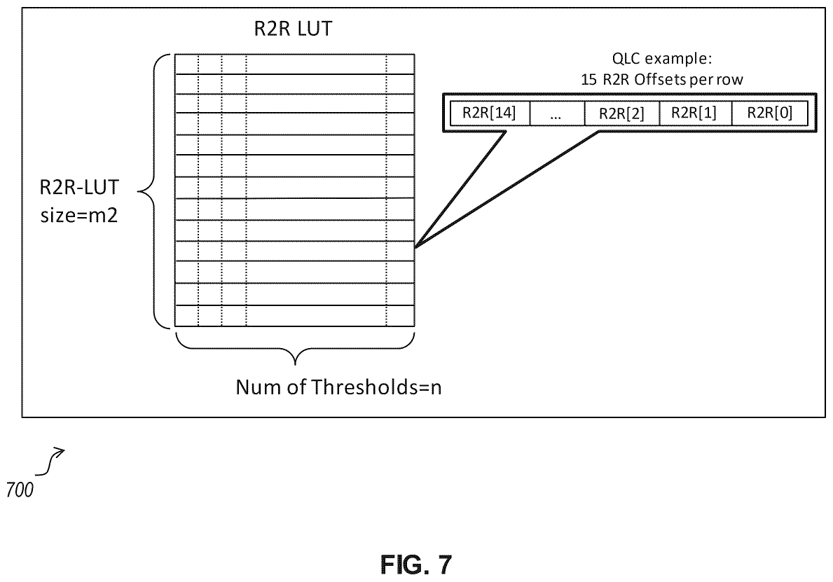

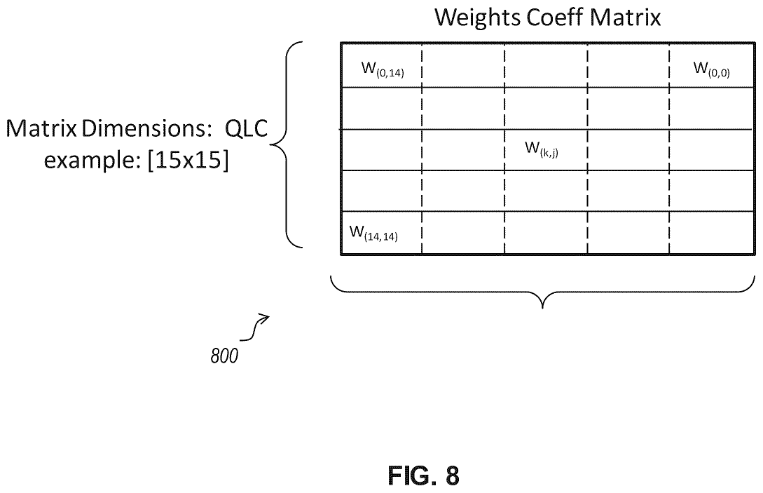

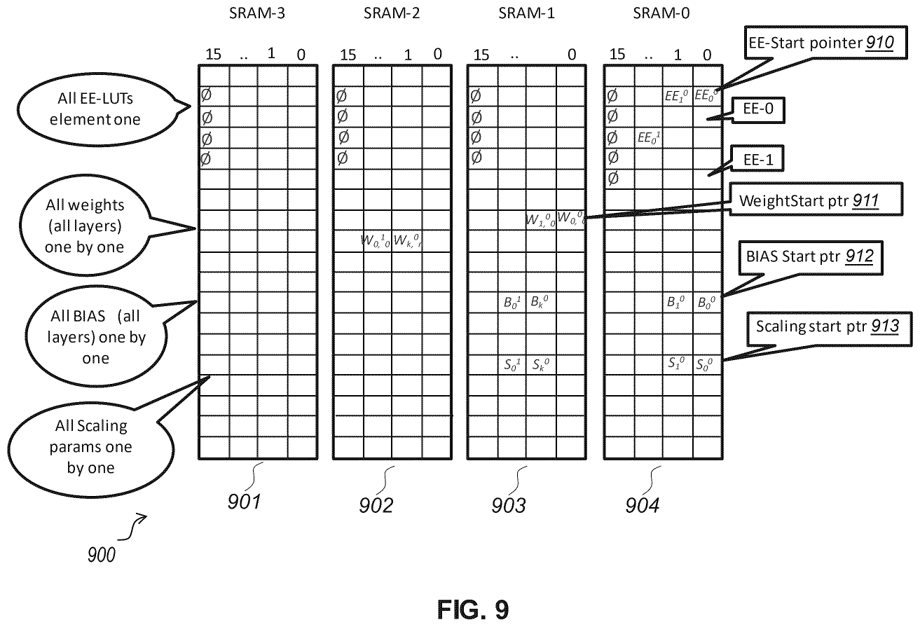

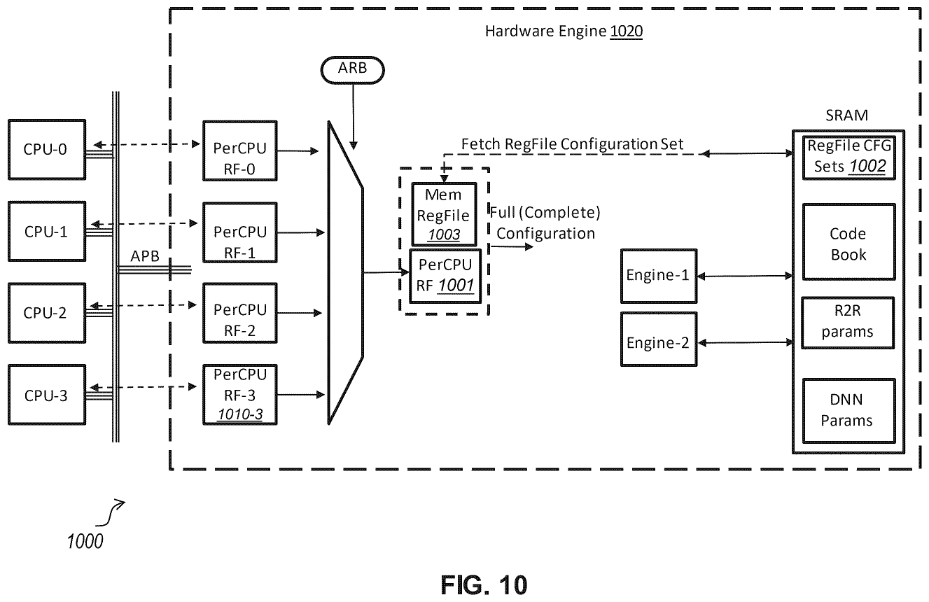

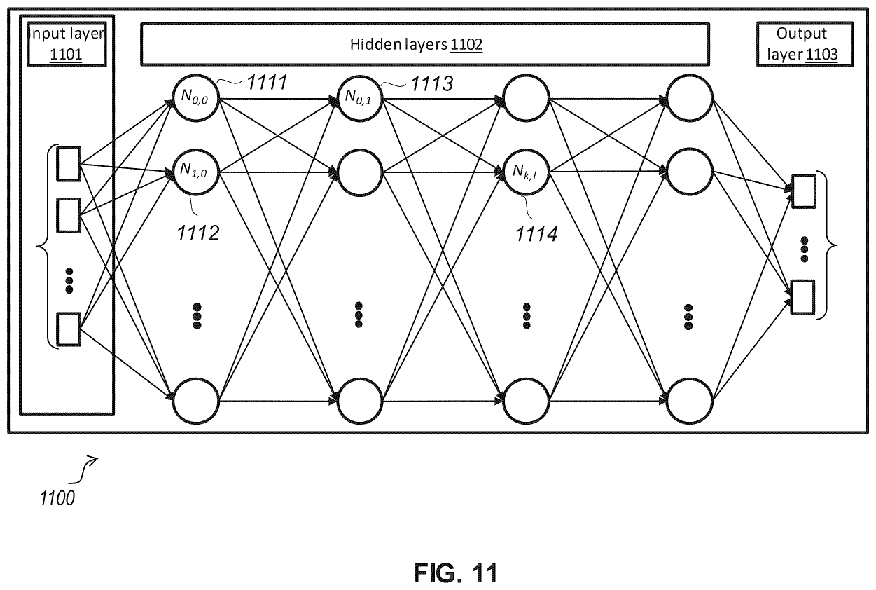

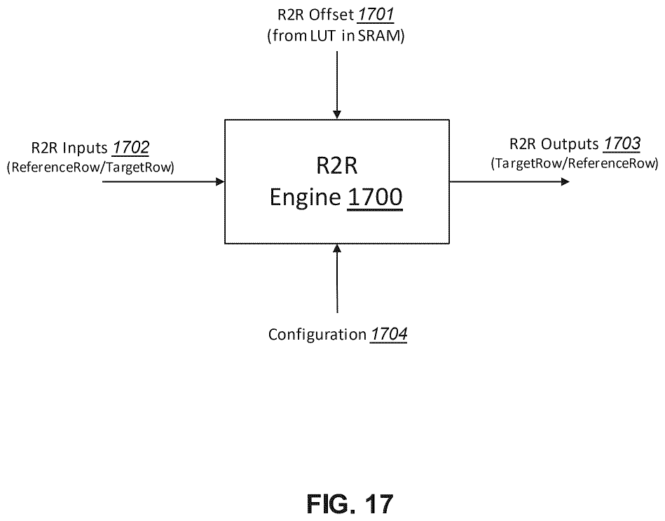

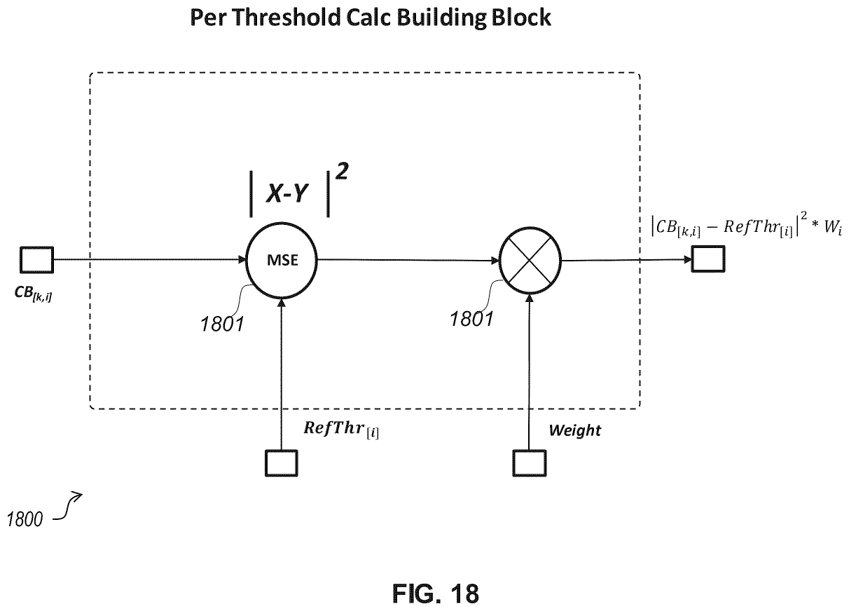

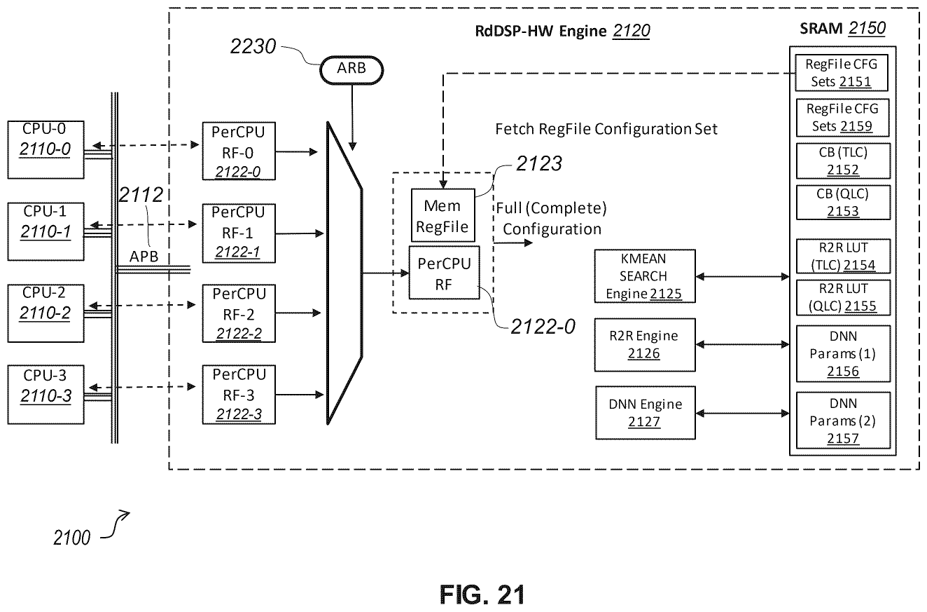

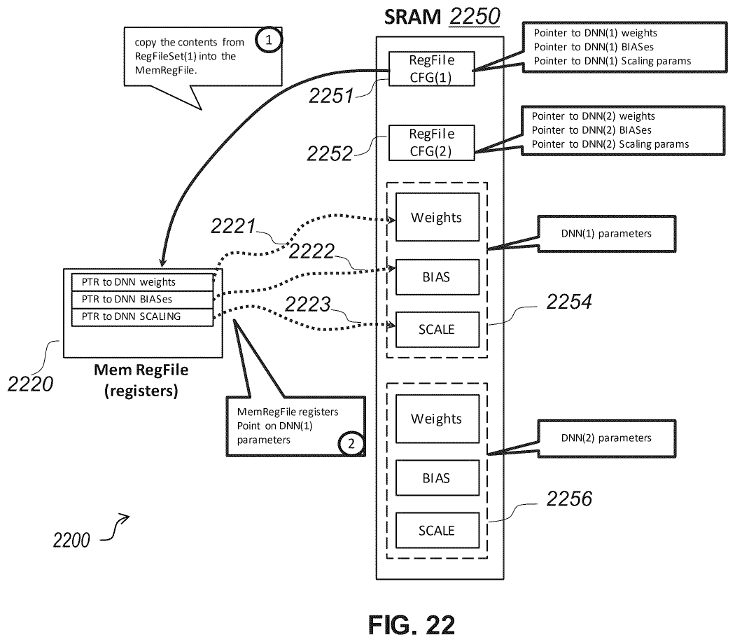

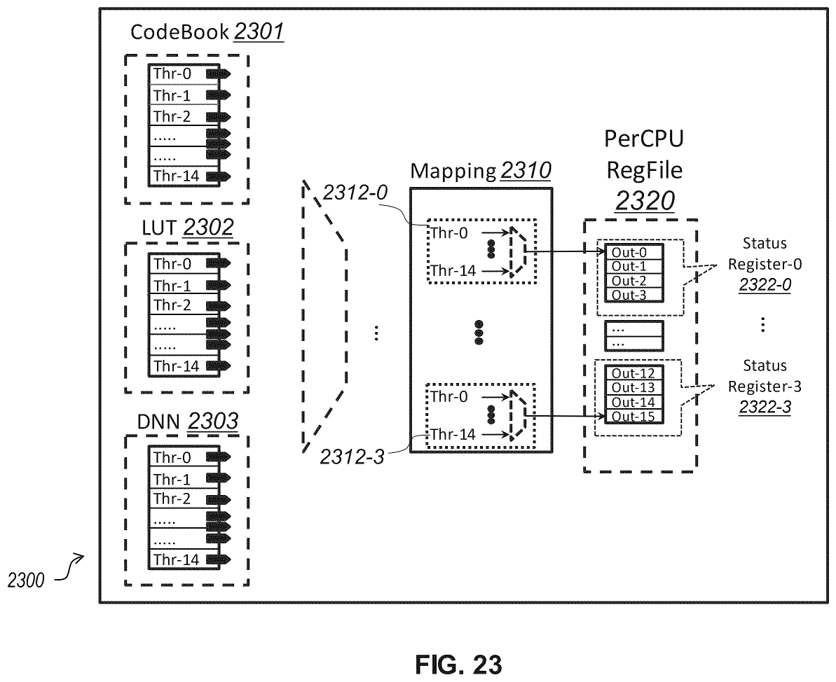

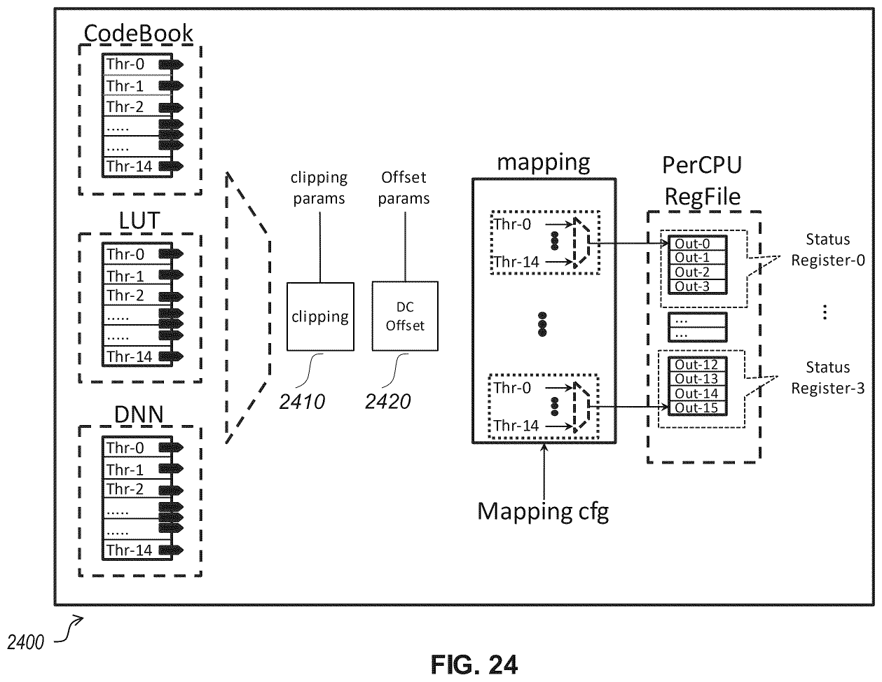

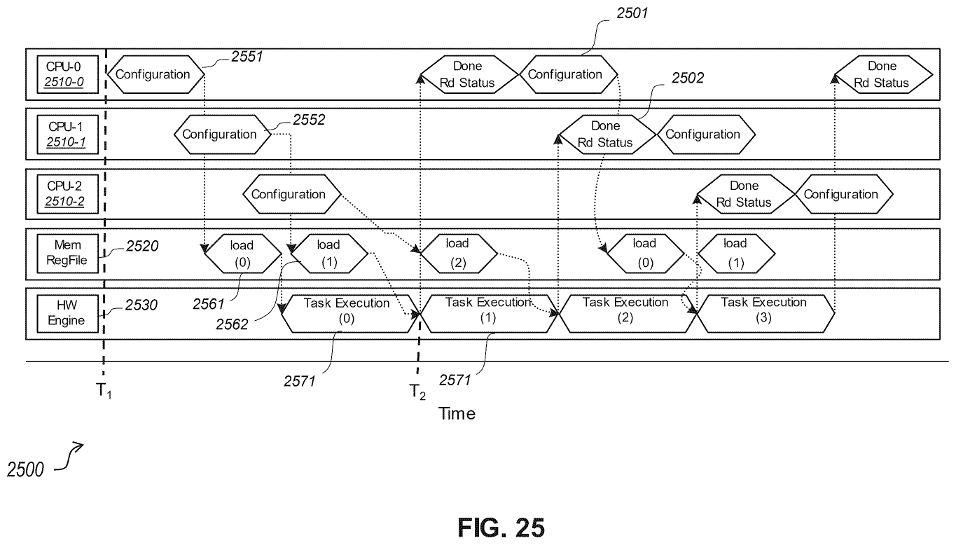

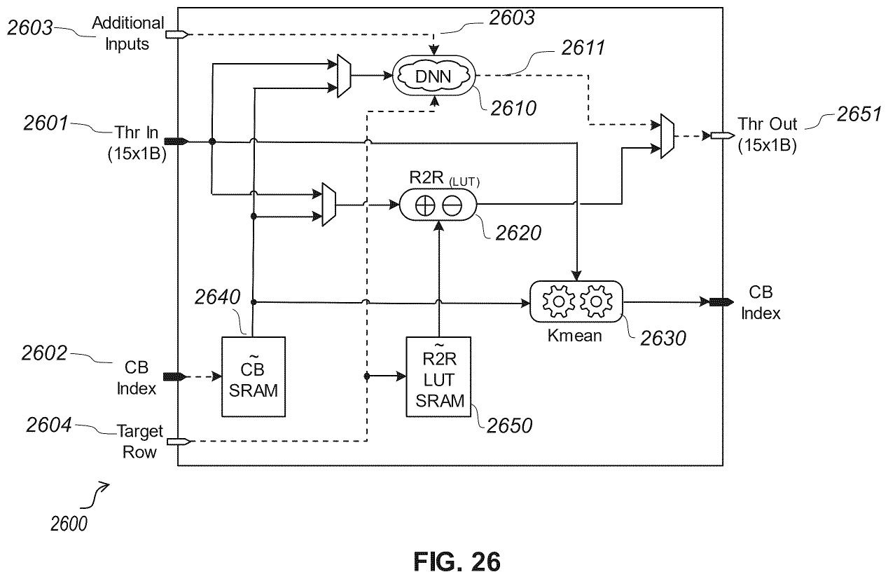

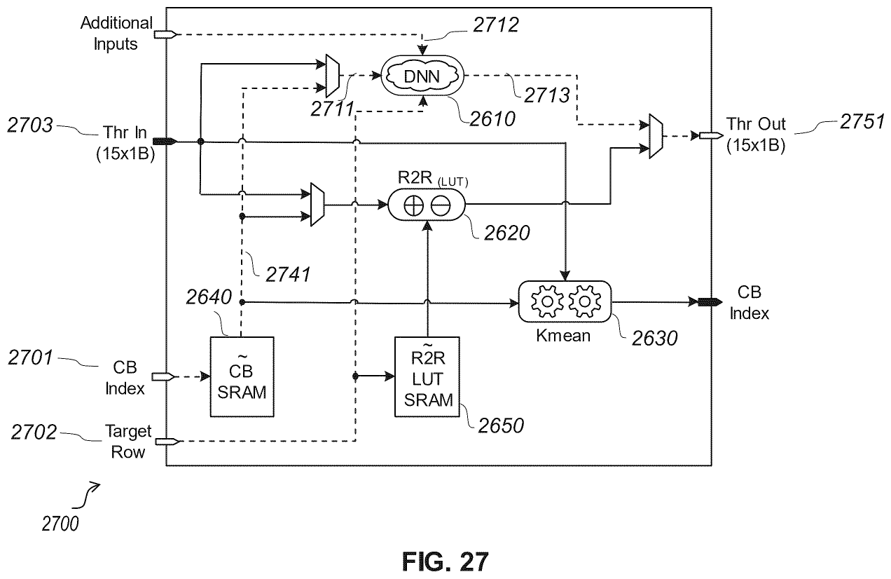

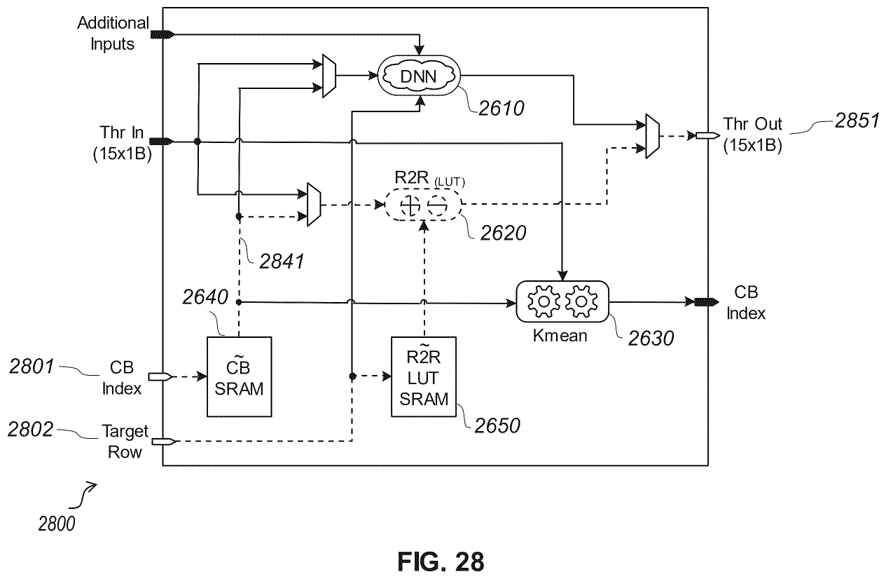

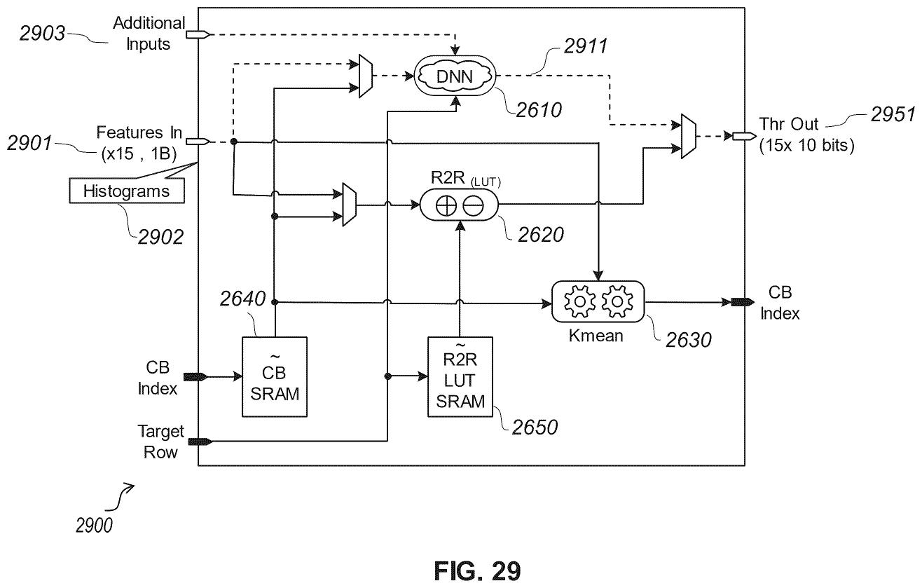

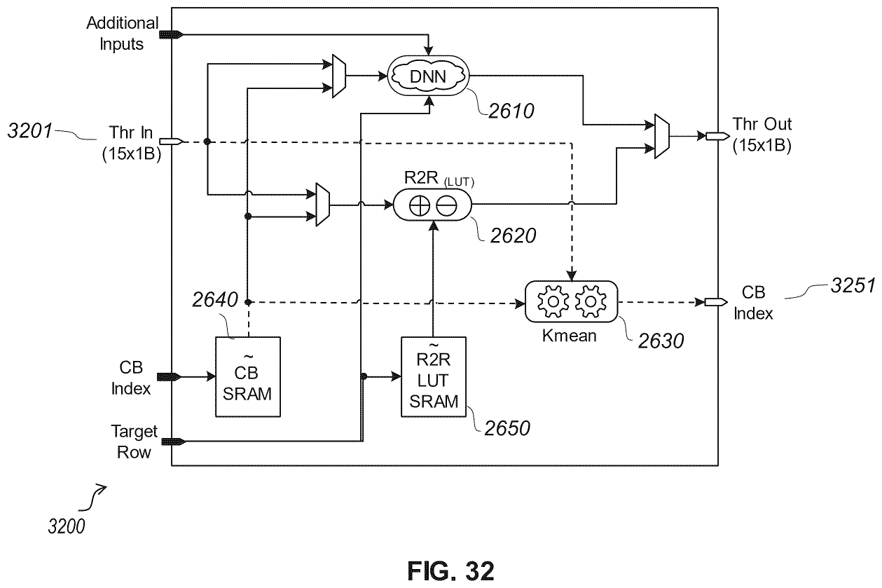

In the following sections, a hardware architecture according to some embodiments will be described in a bottom-to-top manner, e.g., (1) main hardware databases in SRAM, (2) main hardware engines, (3) RDSP-HW top level, (4) main RDSP algorithms, (5) read flow, and (6) read retry flow in this order. The main hardware databases in SRAM (see FIG. 5) may include a codebook (see FIG. 6), R2R LUT (see FIG. 7), K-means weights (see FIG. 8), DNN parameters (see FIG. 9), and regfile configurations sets (see FIG. 10). The main hardware engines may include a DNN engine (see FIG. 11 to FIG. 16), a LUT engine (see FIG. 17), and K-means search engine (see FIG. 18 to FIG. 20). The RDSP-HW top level may include connections of engines/databases/configuration (see FIG. 21), regfile configuration (see FIG. 21), per-CPU regfile (see FIG. 21), mem-regfile (for fast configuration of pre-defined configuration sets; see FIG. 22), mapping feature (for efficient and short read-status; see FIG. 23), clipping and DC offset (see FIG. 24), and operating with multiple CPUs simultaneously (e.g., task scheduling and arbitration; see FIG. 25). The main RDSP algorithms may include a SOL read flow, MOL (middle of life)/EOL (end of life) read flow, and HT-SET (e.g., HT-SET including QT, R2R, and/or K-means search). The SOL read flow may include a codebook (CB) read (e.g., fetch read thresholds from codebook without additional RDSP operations), R2R LUT (e.g., using a dedicated LUT for first/second/third HT-index in order to perform R2R LUT based operation to provide target row thresholds per HTindex), and R2R-DNN (e.g., using a dedicated DNN for first/second/third HT-index in order to perform DNN based operation to provide target row thresholds per HTindex). The MOL/EOL read flow may include R2R-HT (e.g., fetch read thresholds from codebook and perform R2R LUT based operation and/or R2R DNN based operation to provide target row thresholds per set of input thresholds on a reference row). The read flow may include DNN-based HT-GET (e.g., R2R normal, shift, HT; see FIG. 26 and FIG. 27) and LUT-based HT-GET (e.g., R2R normal, shift, HT; see FIG. 28). The read retry flow may include QT (see FIG. 29) and HT-SET (see FIG. 32).

In some embodiments, the system can include main hardware databases in SRAM so that SRAM can be utilized in a hardware architecture (e.g., RDSP-HW). SRAM is typically more efficient than registers (e.g., flip-flops) for large-scale data storage due to its higher density and smaller physical footprint. In a hardware architecture according to some embodiments (e.g., RDSP-HW), SRAM can be utilized to store various databases that are accessed during RDSP operations.

FIG. 5 is a diagram illustrating an example static random access memory (SRAM) structure 500, according to some embodiments. In some embodiments, to enhance access efficiency, the SRAM can be implemented as multiple physical SRAM cuts 501, 502, 503, 504 rather than a single large SRAM block. This approach can increase the bandwidth for accessing SRAM, as each physical SRAM cut can be accessed simultaneously. This design can be particularly effective when the database is accessed sequentially. For example, SRAM can be implemented in four SRAM cuts 501, 502, 503, 504, each with a 16-byte width, and can be used to store databases (e.g., database #1, database #2). The databases can be distributed across the four memories (e.g., four SRAM cuts) in a ping-pong-like configuration. As a result, a sequential read from a database can involve accessing a different physical memory cut in each clock cycle. This arrangement can allow for efficient sequential read transactions from two different clients, effectively utilizing the full bandwidth (16 bytes per cycle for each port). To ensure that two clients do not access the same SRAM cut simultaneously, an arbitration mechanism (e.g., memory arbiter 510) can be implemented. This arbitration can verify access requests and manage the order in which clients access the SRAM cuts, preventing conflicts. Only a minimal initial delay (one-time pushback) can be expected for one client at the beginning of the transaction for one client at the beginning of the transaction.

In some embodiments, a flash memory system (e.g., controller) can include main hardware databases in SRAM to support dynamic allocation of databases in SRAM, allowing for flexibility in algorithm optimization and trade-offs. Databases can be initialized in SRAM before the first usage of the databases, typically after power-up. In some embodiments, these databases are not static, and the database can be adjusted from one setup to another. For instance, to better support a specific flash device, one database can be expanded at the expense of another. In a different setup, a different set of databases may be allocated to optimize RDSP algorithms for another flash device. One constraint in this dynamic allocation may be that the total size of all databases must fit within the available SRAM memory budget. In summary, databases according to some embodiments can be stored in SRAM and used during RDSP operations. This configuration can provide efficiency and density. SRAM can be utilized over registers (e.g., flip-flops) for large-scale data storage due to its higher density and smaller footprint. In some embodiments, the system can provide multiple physical SRAM cuts for increased bandwidth, instead of a single large SRAM block. This design can increase the bandwidth for accessing SRAM, as each cut can be accessed simultaneously (e.g., especially effective for sequential access, which can be used in RDSP operations). In some embodiments, the system can perform dynamic database allocation in SRAM, thereby achieving flexibility to allow optimization of RDSP algorithms and allow the databases to be adjusted from one setup to another to better support different flash devices.

FIG. 6 is a diagram illustrating an example codebook database 600, according to some embodiments. Databases for a hardware architecture according to some embodiments (e.g., RDSP-HW) can include one or more codebooks (CBs). In some embodiments, the databases can include a codebook table that includes m1 sets (e.g., HT CodeBook[0], . . . , HT CodeBook[m1-1]) of read thresholds. Each row in CB contains n Read Thresholds where n is the number of read thresholds. For triple-level cell (TLC), n=7. For quad-level cell (QLC), n=15 as shown in FIG. 6. The CB content in the databases can be offline characterized, and initialized in SRAM prior to a first activation of the hardware architecture (e.g., RDSP-HW). The CB characterization can be performed, for example, based on weighted K-means clustering and/or a vector quantization method. In some embodiments, an HT-Index (which is referred to a specific codebook entry) may be stored in a system memory per block in order to point on (or specify) a set of read thresholds that should be used for this block according to a stress condition of the block. In this manner, only a small amount of information (HT-index) per block can be stored in a memory (e.g., firmware memory). In some embodiments, a regfile configuration can point on (or specify) a CB start address in SRAM and a CB size.

FIG. 6 shows an example to logical view of a codebook database. In this example, the first CB index (CB index 0) can hold or store the normal read thresholds (e.g., the default read thresholds that are used in SOL), and CB indexes 1-3 can hold or store hold shift table read thresholds that may represent a read thresholds that are associated with a common stress condition (for example, light DR (Data Retention)). The read thresholds associated with the common stress condition may be used in case that reading with normal read thresholds fails. Other CB index (e.g., CB index 4 or greater) in the codebook can represent different sets of read thresholds (e.g., n read thresholds) that have been offline characterized to meet different stresses.

FIG. 7 is a diagram illustrating an example row-to-row (R2R)-look-up table (LUT) database 700, according to some embodiments. In some embodiments, the databases for a hardware architecture according to some embodiments can include a table (referred to as R2R table or R2R LUT) including row-to-row offsets (R2R offsets). In some embodiments, an R2R table can include m2 sets (or rows) and each row can include n offsets from reference row read thresholds (e.g., read thresholds of a reference row). For example, for TLC, n=7, and for QLC, n=15. Each entry in a R2R-LUT can represent an offset from a reference row threshold. The content of the R2R-LUT can be offline characterized, and initialized in SRAM prior a first activation of the hardware architecture (e.g., RDSP-HW). In some embodiments, a regfile configuration can point on (or specify) a R2R table start address in SRAM and/or a R2R table size. An example of a logical view of a R2R LUT database is described in FIG. 7. In this example, the first row of the R2R LUT can hold or store offsets from reference row read thresholds to first row read thresholds. In some embodiments, when a read command to the first row of block X is received, the system (e.g., controller) can first extract the reference row read thresholds from a codebook according to HT-Index that exists in firmware memory for block X). The system can then perform a linear operation in order to estimate the first row read thresholds based on the reference row read thresholds, obtain the corresponding offsets from the first row of the R2R LUT, and apply the obtained offsets (e.g., offsets from the reference row read thresholds) to the (estimated) first row read thresholds. For example, the offsets to the first row, from the R2R LUT, can be applied to the reference row threshold, to provide the estimated thresholds of the first row, which are used for reading the first row of block X.

FIG. 8 is a diagram illustrating an example weights coefficient matrix 800, according to some embodiments. In some embodiments, the databases for a hardware architecture according to some embodiments can include K-means search weights (e.g., W_{(0,0)}, . . . , W_{(0,14)}, . . . , W_{(14,14)}). In some embodiments, a K-means search operation can find an index of the nearest central point (e.g., row) in a codebook to the reference row read thresholds based on weighted MSE (Mean Squared Error) metric. In some embodiments, during a K-means search, weights (per-row, per read threshold) can be used. A matrix of coefficients can be used to calculate estimated weights per reference row. The content of the matrix of coefficients can be initialized in SRAM prior to a first activation of the hardware architecture (e.g., RDSP-HW). For example, the size of a weights coefficients matrix can be [7B×7B]=49 Bytes in TLC case, and the size of a weights coefficients matrix can be [15B×15B]=225 Bytes in QLC case. For each K-means search operation, the weights for a specific row can be calculated based on input row thresholds and the weights coefficient matrix. In some embodiments, a regfile configuration can point on (or specify) the start address of a weights coefficient matrix in SRAM and a size of the matrix.

FIG. 9 is a diagram illustrating an example of DNN parameters placement 900 in memory, according to some embodiments. FIG. 9 illustrates an example placement of DNN parameters in memory, which are spread over 4 physical SRAM cuts 901, 902, 903, 904. In some embodiments, the databases for a hardware architecture can include DNN parameters (or parameters of any other machine learning model). In some embodiments, DNN parameters may include weights (e.g., W_{0,0}, W_{1,0}, . . . ), biases (e.g., B₀, B₁, . . . ), EE (Entity Embedding) LUTs element (e.g., EE₀, EE₁, . . . ), and/or scaling parameters (e.g., S₀, S₁, . . . ). Weights can be used during a MAC (Multiply and Accumulation) calculation. Biases can be used after MAC phase is completed. EE can be used in order to efficiently represent categorical input features in a DNN input layer. Scaling parameters can be used in order to better utilize the dynamic range of the weights/biases/activations during a neuron calculation. Each network (e.g., neural network) can have its own set of parameters (according to network usage) generated during an offline training process. In some embodiments, a regfile configuration can point on (or specify) a start address of each parameter in SRAM (e.g., EE start pointer 910, weight start pointer 911, bais start pointer 912, scaling start pointer 913) and a size of each parameter. The regfile configuration can describe also a network architecture (e.g., the number of hidden layers, per layer width, etc.).

In some embodiments, the databases for a hardware architecture according to some embodiments can include regfile configuration sets. In conventional architectures, register file (regfile) are configured by firmware (FW) to define a specific usage of a hardware engine. Each CPU typically accesses its own regfile, known as the per-CPU regfile. A hardware architecture according to some embodiments (e.g., RDSP-HW architecture) introduces a more efficient approach through the use of “regfile configuration sets” that are stored in SRAM in advance.

In some embodiments, the regfile configuration sets can be offline prepared and stored (or initialized) in SRAM memory, for example during power-up. When a specific read operation (e.g., RDSP operation) is invoked or instructed, a system (e.g., CPU or firmware) can configure, in per-CPU regfile, a pointer to an appropriate regfile configuration set in SRAM, and the system (e.g., hardware or circuit) can fetch the regfile configuration set from SRAM into a mem-regfile (e.g., regfile that is loaded from memory, rather than APB interface). The mem-regfile can be loaded just before the read operation is performed. In this manner, a specific engine within the hardware architecture according to some embodiments (e.g., RDSP-HW) can be activated with a corresponding regfile configuration set.

In some embodiments, a flash memory system can support a simultaneous access by multiple CPUs to its per-CPU regfile, with each CPU viewing the hardware architecture (e.g., RDSP-HW) as a distinct virtual machine that includes a dedicated regfile configuration space (per-CPU regfile in memory).

The regfile configuration according to some embodiments can have the following advantages. First, the system can achieve a shorter CPU configuration time. Firmware-based regfile configuration can introduce latency, particularly when compared to the hardware process of quickly fetching data from SRAM according to some embodiments. For example, CPUs typically configure hardware units through the Advanced Peripheral Bus (APB), which is designed to interface slower peripheral devices with the main processor or core in a system on chip (SoC). The overall latency of read operations (e.g., RDSP operations) may include three steps: (1) firmware configuration, (2) hardware processing, and (3) firmware read status. To meet system performance requirements (e.g., requirements in metrics such as IOPS or throughput), especially during read-flow operations at SOL, minimizing read operation latency may be crucial. Using regfile configuration sets can help to reduce this overall latency by shortening the CPU configuration time. When multiple CPUs are connected to an identical regfile through a single APB fabric, the configuration by one CPU can block others from accessing their per-CPU regfile. In some embodiments, the system can allow the firmware to configure a single pointer to a regfile configuration set, thereby enhancing efficiency and reducing APB traffic.

Second, the regfile configuration according to some embodiments can achieve area saving for at least the following reasons. In a traditional setup, where multiple CPUs access hardware for read operations, each CPU may maintain a duplicated regfile configuration set in its virtual machine. For example, if a specific regfile configuration set is needed for a DNN operation, the specific regfile configuration set must be duplicated for each CPU. On the other hand, in some embodiments of the present disclosure, only a single regfile configuration set can be loaded in the mem-regfile, while all available configurations for this set are stored in SRAM, thereby eliminating the need for duplication, and thereby saving area. This architecture can enable multiple CPUs to access a single RDSP-HW unit. Thus, the architecture also can reduce area, because there is a single RDSP-HW units that works with multiple CPUs, rather than a dedicated RDSP-HW unit per CPU. This architectures can configure (over APB) only a pointer to SRAM (instead of configuring a full configuration), thereby minimizing the APB traffic. The RDSP-HW logic can fetch a pre-defined configuration in SRAM according to the pointer and copy the pre-defined configuration in SRAM to a mem-regfile.

In summary, in some embodiments of the present disclosure the system can enable fast configuration by copying a configuration set from SRAM to a register file in a memory (e.g., mem-regfile), thereby being faster than the traditional advanced peripheral bus (APB) configuration, and reducing a CPU configuration time, and minimize APB traffic The system can enable multiple CPUs to access the read operation block or unit (e.g., RDSP-HW unit) for configuration, read status, or polling simultaneously. The system can achieve area saving because the configurable architecture uses only a single mem-regfile instantiation rather than duplicating in per-CPU regfile for each CPU, and because of the fact the multiple CPUs use a single unit (e.g., RDSP-HW unit), rather than a dedicated unit (e.g., RDSP-HW unit) per CPU.

FIG. 10 is a diagram illustrating an example system environment 1000 of hardware engine 1020 (e.g., Read DSP HW architecture or engine) implementing a scheme of register file (regfile) configuration sets, according to some embodiments. As shown in FIG. 10, each CPU (e.g., CPU-0, CPU-1, CPU-2, CPU-3) can simultaneously configure its own per-CPU regfile (e.g., RF-0, RF-1, RF-2, RF-3). The configuration may involve setting dedicated registers within the per-CPU regfile and assigning a pointer in the per-CPU regfile (e.g., per-CPU RF 1001) to a specific regfile configuration set (e.g., RegFile CFG sets 1002) stored in SRAM. When the hardware selects a particular RDSP operation from a specific per-CPU regfile (e.g., per-CPU RF 1001) to execute, the hardware can fetch the corresponding configuration data from SRAM into the mem-regfile (e.g., mem-regfile 1003). The selected per-CPU regfile, combined with the updated mem-regfile, can form the complete configuration required to perform the RDSP operation.

FIG. 11 is a diagram illustrating an example fully-connected (FC) Deep Neural Network (DNN) 1100, according to some embodiments. The example DNN may include an input layer 1101, one or more hidden layers 1102, and/or an output layer 1103. The hidden layers 1102 may include a plurality of neurons in each layer, for example, neurons 1111, 1112 in a 0^{th} layer, a neuron 1113 in a 1^{st} layer, a neuron 1114 in a l^{th} layer, etc. In a hardware architecture according to some embodiments, a flash memory system can include a DNN engine as one of main hardware engines. The DNN engine can be used to perform inference tasks using a DNN (e.g., DNN 1100). This engine can include a series of processing elements that perform DNN computations in parallel. The main data path can include a parallel multiply-accumulate unit (MAC) and a non-linear activation function (ReLU), enabling the DNN engine to perform non-linear computations quickly and efficiently with a low latency and low power consumption compared to conventional firmware/software implementations. In some embodiments, the DNN engine can be highly configurable, and can be used for several tasks like QT, R2R and other tasks. The DNN engine can calculate an inference result of a fully-connected (FC) network (in an output layer), based on the inputs (in an input layer), network architecture (e.g., network length, width). The network parameters (e.g., weights, biases, scaling parameters) can be configurable, and can be stored in SRAM.

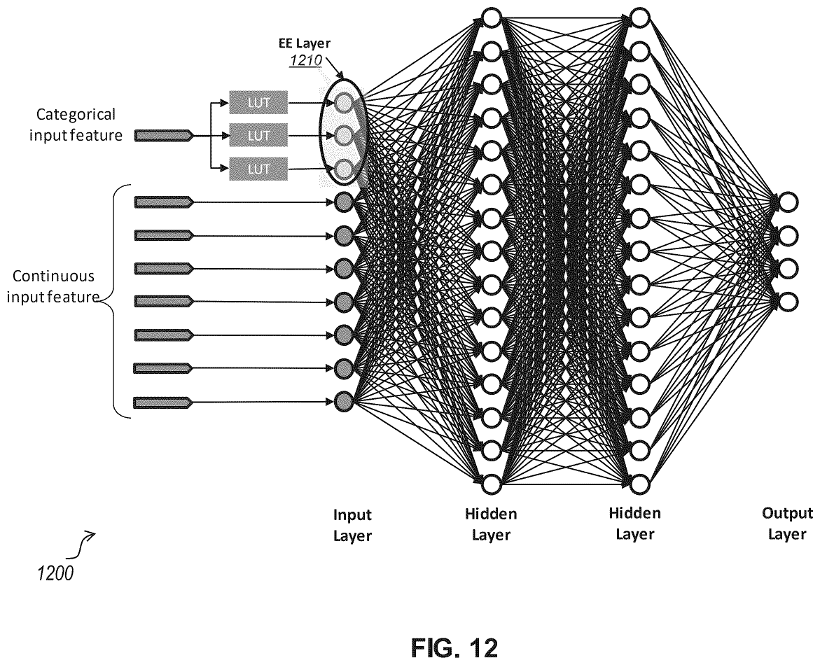

FIG. 12 is a diagram illustrating an example entity embedding scheme 1200, according to some embodiments. In some embodiments, weights and biases that are stored in the SRAM may be used for different DNNs. For example, for QT or R2R, different coefficients can be used, and different DNN architectures can be used. For example, the number of layers and/or number of neurons per layer may be different for various estimation tasks. The DNN HW engine includes multiple configurable multiply-accumulate (MAC) modules, and uses them in parallel, and according to network configuration.

In some embodiments, the DNN engine can be configured for read operations which are performed in a streaming mode, which means that a maximal read throughput can be attained, and the DNN engine can perform operations like HT-Get and R2R per read command within the data-path to provide optimized thresholds per page-read.

In some embodiments, the DNN-Engine can support Entity Embedding (EE) technique as described below. EE is a technique that is used to represent categorical features in DNNs. Categorical features are those that take on a limited set of values, such as row number or WL (word line) number. Typically, categorical features can be represented using a one-hot encoding, which requires a large number of input neurons and can be computationally expensive. Entity embedding (EE) can address this issue by using an intermediate layer (referred to as “EE layer”; e.g., EE layer 1210) of neurons connected to the one-hot representation. For an efficient hardware implementation, the intermediate layer of neurons (e.g., the EE layer) can be offline calculated for each value of the one-hot input feature in the form of LUT, and the EE layer (e.g., LUT) can be stored in SRAM.

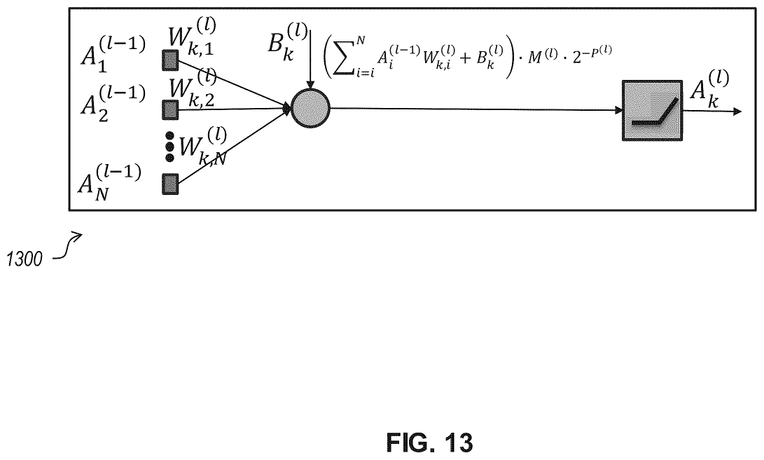

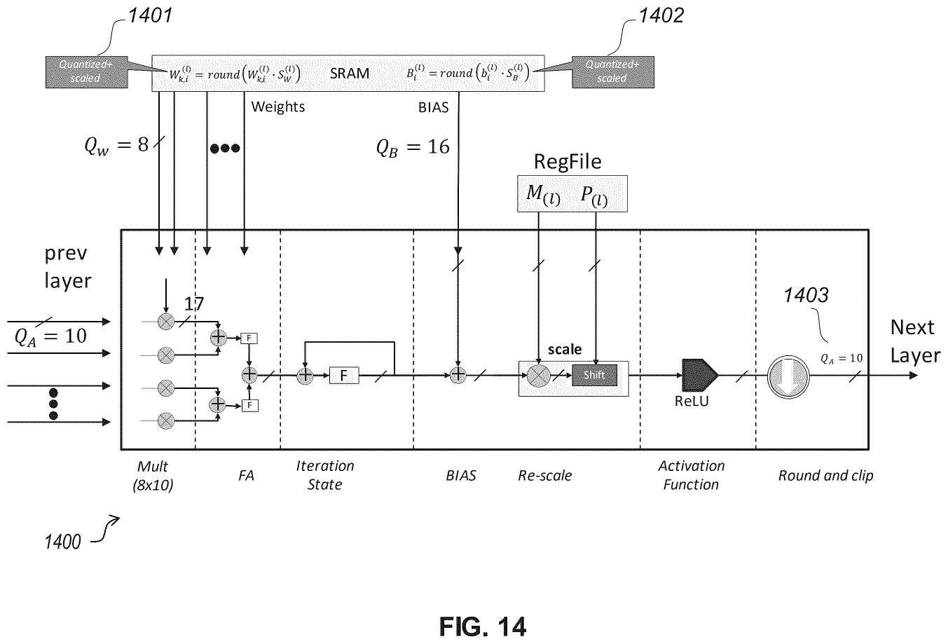

A basic computational unit that implements a ReLU neuron computation from a set of inputs multiplied by the corresponding values is illustrated in FIG. 13 and FIG. 14. FIG. 13 is a diagram illustrating an example of fixed-point calculation 1300 of a neuron in a layer, according to some embodiments. The fixed-point calculation of the k^{th} Neuron in l^{th} layer (e.g., neuron 1114 in FIG. 11) is described below

$$Hidden layer : {A}_{k}^{l} = {CLIP}_{[ {Q}_{A} bits ]} \{ ReLU \{ Round [ ( {\sum }_{i = 1}^{N} {A}_{i}^{( l - 1 )} {W}_{k , i}^{( l )} + {B}_{k}^{( l )} ) * {M}^{( l )} \cdot {2}^{- {P}^{( l )}} ] \} \} \qquad ( Equation 5 )$$

where M(l) and P(l) are scaling factors that are used in order to better utilize the confidents dynamic range, and are calculated offline.

FIG. 14 is a diagram illustrating an example architecture of fixed-point calculation scheme 1400, according to some embodiments. In order to perform this fixed-point calculation (see Equation 5) in a high bandwidth, a fixed-point calculation scheme according to some embodiments can perform the arithmetical calculation of each neuron in a neural network using the following bit widths which are defined according to quantization policy:
Q_{A}=10 [bits] (for rounding and clipping a result of an activation function (e.g., ReLU); 1403 in FIG. 14);
Q_{W}=8 [bits] (for quantizing and scaling

$${W}_{k , l}^{( l )} ;$$

### 1401 In FIG. 14);

Q_{B}=16 [bits] (for quantizing and scaling

$${B}_{i}^{( l )} ;$$

### 1402 In FIG. 14);

where QA, QW, QB indicate a bit width of activations, weights, and biases, respectively.

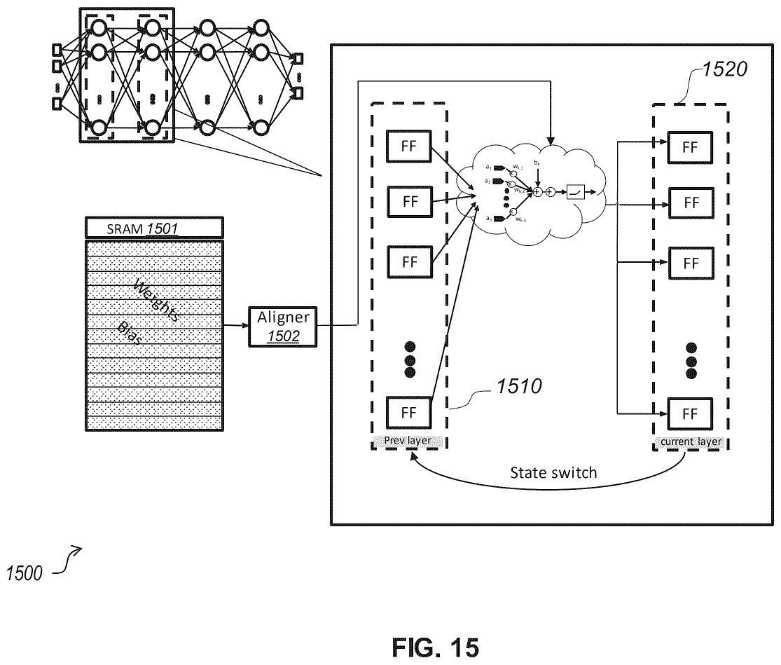

FIG. 15 is a diagram illustrating an example DNN computation scheme 1500, according to some embodiments. In some embodiments, a DNN engine can perform an arithmetical calculation to each neuron in the (neural) network. In some embodiments, all network parameters (e.g., weights/bias) can be stored in SRAM 1501. Data can be fetched from SRAM in-order (using an aligner 1502), and provided to the DNN engine according to an in-order calculation progress. The DNN engine can have two arrays (e.g., previous layer 1510, current layer 1520) of registers (e.g., flip-flop or FF) that hold the previous layer activation values and current layer activation values, respectively, as demonstrated in FIG. 15.

In some embodiments, a DNN engine can perform calculation processing based on two layers (e.g., a current layer 1520 and a previous layer 1510 as shown in FIG. 15). Data for the calculation processing (e.g., activations, biases, weights, metadata) can be stored in registers (e.g., FFs in FIG. 15). In some embodiments, the number of registers can be determined according to a maximal layer width. In some embodiments, the DNN engine can perform all calculation steps in pipeline. In some embodiments, inputs of the calculation processing may include previous layer neurons and/or relevant data (e.g., activations, biases, weights, metadata). In some embodiments, an order of the calculation processing may be determined based on an order of processing layers (e.g., a layer-by-layer order) and/or and order of processing neurons in the same layer (e.g., a neuron-by-neuron order in each layer). In some embodiments, the DNN engine can perform a layer switch such that in order to move to a next layer calculation, the current layer is switched to the previous layer and the next layer is switched to the current layer. FIG. 15 shows registers (e.g., FFs) in the current layer and registers in the previous layer.

In some embodiments, the DNN engine can perform MAC (Multiply and Accumulate) operations or sections in parallel. In some embodiments, the DNN engine can determine an engine bandwidth or bandwidth requirements that a system (e.g., NAND flash device) can achieve, and determine the number of multipliers (as a parallel factor) according to the engine bandwidth (see multipliers and adders in FIG. 14). For example, if the bandwidth requirements of performing 16 MAC operations in one cycle, the DNN engine can initiate 16 multipliers. In some embodiments, the DNN engine can fetch, from SRAM, the weights that are needed for each multiplication operation. Storing weights in SRAM can provide the following two advantages. First, SRAM can provide efficient area and/or power to store this information compared to storing weights in registers. Second, weights can be read in high bandwidth, according to the parallel factor. For example, one row in SRAM can store a number of weights that are required to perform a MAC operation according to a parallel factor. In some embodiments, multiple SRAM can be implemented in order to provide as much weights per cycle as needed.

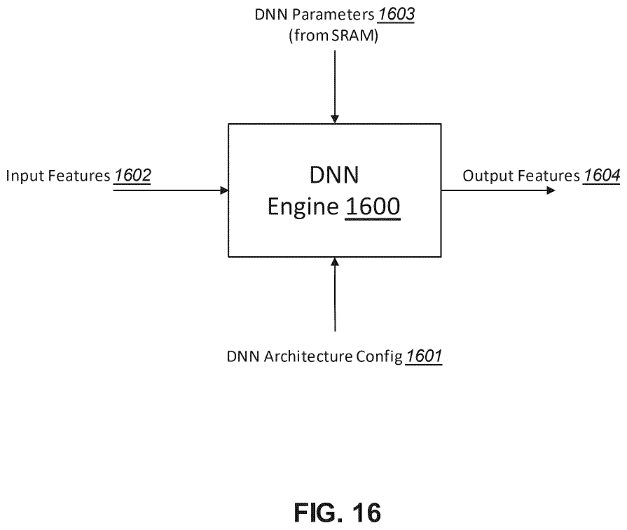

FIG. 16 is a diagram illustrating example DNN engine main interfaces 1600, according to some embodiments. In some embodiments, a DNN engine can receive or obtain network configurations 1601 (for example, from a register file configured by a CPU). The DNN engine can receive or obtain input features 1602 at an input layer (for example, from a register file configured by a CPU). The DNN engine can receive or obtain network parameters 1603 from SRAM (for example, SRAM can be offline configured by a CPU). The DNN engine can calculate output features 1604 in a high bandwidth, and provide outputs (for example, output to a register file, readable by a CPU).

FIG. 17 is a diagram illustrating example R2R engine main interfaces 1700 (e.g., R2R-LUT engine), according to some embodiments. In some embodiment, an R2R engine (or R2R-LUT engine) can perform a linear R2R transformation based on a LUT in SRAM. In some embodiments, an offset-LUT which stores voltage thresholds offsets 1701 can be stored in SRAM and used for a transformation from R2R_IN (e.g., input 1702 to the R2R transformation) to R2R_OUT (e.g., output 1703 of the R2R transformation).

In some embodiments, the content of k^{th} row of a LUT can be an offset from the reference row (per threshold). In this case, the R2R engine can calculate R2R_Out as follows:

$$R2R\_OUT = R 2 {R}_{IN} \pm R 2 {R}_{LUT [ Target \_ Row ]} \qquad ( Equation 6 )$$

In some embodiments, R2R Inputs 1702 may include one of (1) reference row read thresholds from a codebook (according to a HT-Index) or (2) a target row read thresholds from a regfile. For R2R configuration 1704, a flash memory system (e.g., CPU or firmware) can configure a regfile to include pointers to a start address of a R2R-LUT in SRAM and a size of the R2R-LUT. The regfile can include a R2R transformation direction bit indicating (1) a direction from the target row to the reference row (add), or (2) the reference row to the target row (subtract). The add or subtract can be related to the estimation process using R2R. For the direction (1), the system can use the target to thresholds to estimate the reference row thresholds. For the direction (2), the system can use the reference row thresholds to estimate the target row thresholds. These are two opposite R2R directions.

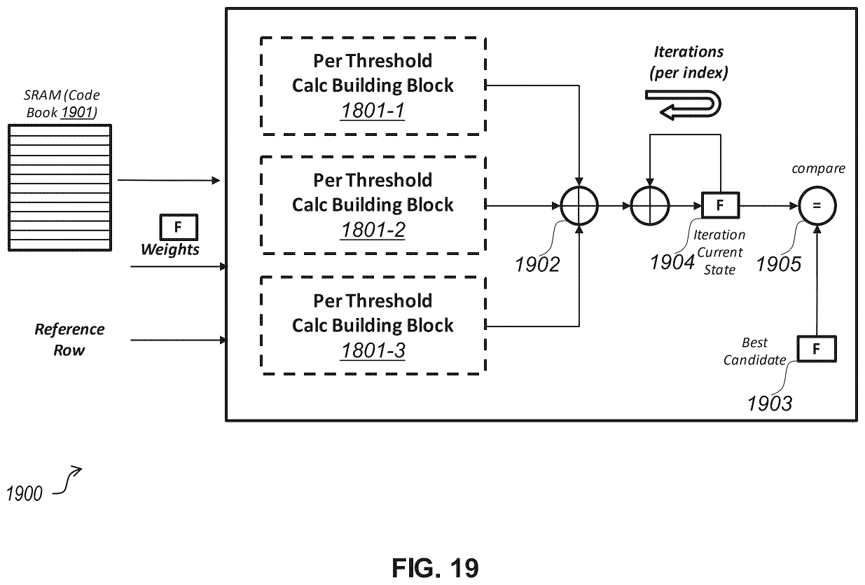

FIG. 18 is a diagram illustrating an example instance of per-threshold calculation building block 1800, according to some embodiments. FIG. 19 is a diagram illustrating an example of iterative K-means search (or a K-means search engine) 1900 based on 3 instances of per-threshold calculation building block, according to some embodiments.

In some embodiments, a flash memory system may include a K-means search engine 1900. The K-mean search engine or operation can find an index of the nearest central point in a codebook 1901 to the reference thresholds according to weighted MSE (e.g., MSE 1801 multiplied 1802 by a weight). The K-means search engine can calculate a codebook index as following: In a first step, the K-means search engine can perform a weights calculation according to a target row. In a second step, for each K-means search operation, the K-means search engine can calculate the weights for the specific row based on input row thresholds and a weights coefficient matrix. For example, K-means weights can be calculated as following:

$${W}_{i} = \{ {\sum }_{k = 0}^{N - 1} [ {Coeff\_Matrix}_{[ i , k ]} * Target\_Row {\_Thr}_{[ k ]} ] \} \qquad ( Equation 7 )$$

where N=7 (TLC); N=15 (QLC).

In a third step, the K-means search engine can find a HT-Index (e.g., a row number or CB index in a codebook) that represent the read thresholds that are nearest to the reference row read thresholds (in term of added errors) by searching or scanning over all entries in the codebook and comparing the read thresholds to the reference row. The calculation can be done as following:

$$CB\_INDEX = Find \{ {min}_{k} {\sum }_{i = 0}^{N - 1} {\vert {CB}_{[ k , i ]} - {RefThr}_{[ i ]} \vert}^{2} * {W}_{i} \} \qquad ( Equation 8 )$$

where N=7 (TLC); N=15 (QLC).

In some embodiments, in order to accelerate K-means search operations, the K-means search engine can use a per-threshold calculation building block 1800 (for each index i) to calculate a weighted distance from a reference row threshold (see FIG. 19). As shown in FIG. 19, multiple instantiations (or instances) of this per-threshold calculation building block (e.g., 3 blocks 1800-1, 1800-2, 1800-3) can each calculate the weighted-distance from different thresholds in parallel. The more instantiations of this per-threshold calculation building block the K-means search engine has, the lower latency for K-means search algorithm (a trade-off between a gate count and K-means search latency) the K-means search engine can achieve. In some embodiments, the results of all weighted distances can be accumulated 1902 until all thresholds are calculated (for a single row or CB entry, for example, 7 thresholds for TLC, 15 thresholds for QLC). As shown in FIG. 19, the best candidate 1903 may be a variable that is initialized to MAX_VAL and represents the value of the minimal weighted distance sum of all thresholds. Once the calculation of the weighted distance sum 1904 of all thresholds is completed, the weighted distance sum of all thresholds 1904 can be compared 1905 to the best candidate 1903, and the weighted distance sum of all thresholds and a CB entry (which is the HT-index) can be saved (or updated) only if its current value of the weighted distance sum of all thresholds is smaller than the best-candidate value.

In some embodiments, the K-means search can go over all clusters in a codebook. In some embodiments, the K-means search engine can perform an ArgMin search which calculates a weighted Euclidean distance for each cluster in the codebook. The number of operations per cluster can be 7 (for TLC) or 15 (for QLC). The throughput of K-means search can be 3 operations/cycle (see FIG. 19). In this case, the total latency can be calculated as follows:

$$Total latency \sim O ( NumOfRowsInCB * n / NumOfBuldingBlocks ) , \qquad ( Equation 9 )$$

where n=7 (TLC) or 15 (QLC).

In addition, weights can be calculated according to an input reference row.

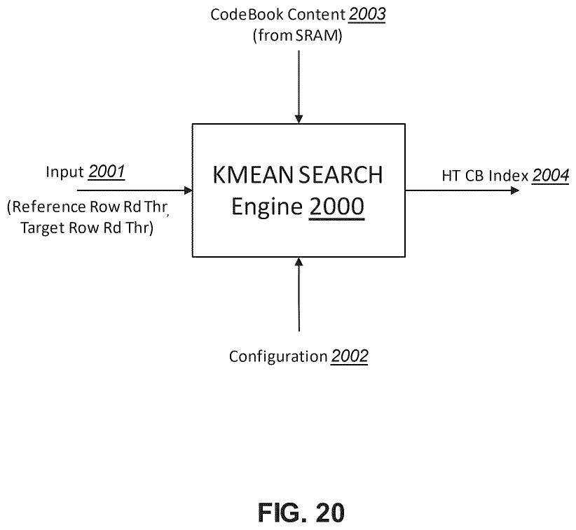

FIG. 20 is a diagram illustrating an example of K-means search engine main interfaces 2000, according to some embodiments. In some embodiments, inputs 2001 to the K-means search engine can include (1) a reference row provided by a regfile interface (e.g., per-CPU regfile), and/or (2) a target row provided by a regfile interface (e.g., per-CPU regfile). In some embodiments, a system (e.g., CPU or firmware) can configure 2002, in a regfile, (1) pointers to a start address of a codebook in SRA and/or a size of the codebook in SRAM, and/or (2) pointers to a start address of a weights coefficients matrix in SRAM and/or a size of the weights coefficients matrix in SRAM. In some embodiments, in response to obtaining codebook content 2003 from SRAM, the K-means search engine can output a HT-index 2004 (e.g., a code-book entry).

FIG. 21 is a diagram illustrating an example system environment 2100 of a top-level architecture implementing read operation hardware, or a read hardware engine 2120 (e.g., Read DSP Hardware engine/architecture), according to some embodiments. FIG. 22 is a diagram illustrating an example scheme 2200 of loading mem-regfile, according to some embodiments.

FIG. 21 depicts the RDSP-HW top level, with algorithms for both TLC and QLC. The read hardware engine 2120 may include SRAM 2150 storing RegFile CFG sets 2151, RegFile CFG sets 2159, a codebook for TLC 2152, a codebook for QLC 2153, an R2R LUT for TLC 2154, an R2R LUT for QLC 2155, a first set of DNN parameters 2156, and/or a first set of DNN parameters 2157. The read hardware engine 2120 may include a K-means search engine 2125 (e.g., K-means search engine 2000), an R2R engine 2126 (e.g., R2R engine 1700), and/or a DNN engine 2127 (e.g., DNN engine 1600). When a task that is associated to TLC operation is performed, the CPU can configure an appropriate configuration and an appropriate pointer to a regifile configuration set. As shown in FIG. 21, each CPU 2110-0, 2110-1, 2110-2, 2110-3 can simultaneously configure its own per-CPU regfile 2122-0, 2122-1, 2122-2, 2122-3 via an APB 2112. In other words, each CPU can configure its own per-CPU regfile independently and simultaneously. The configuration may involve setting dedicated registers within the per-CPU regfile and assigning a pointer in the per-CPU regfile (e.g., per-CPU regfile 2122-0) to a specific regfile configuration set (e.g., RegFile CFG sets 2152) stored in SRAM 2150. When an arbitration and management control (system) 2230 selects a particular RDSP operation from a specific per-CPU regfile (e.g., per-CPU RF 2122-0) to execute, the hardware can fetch the corresponding configuration data (e.g., regfile CFG sets 2151) from SRAM 2150 into a mem-regfile (e.g., mem-regfile 2123) in a memory (e.g., DRAM 3310). The mem-regfile may include one or more registers. The selected per-CPU regfile 2122-0, combined with the updated mem-regfile 2123, can form the complete configuration required to perform the RDSP operation.

A top level of a hardware architecture according to some embodiments (e.g., RDSP HW) may be composed on engines (e.g., K-means search engine 2125, R2R-LUT engine 2126, DNN engine 2127), SRAM 2150, per-CPU regfile 2122-0, 2122-1, 2122-2, 2122-3, mem-regfile 2123, and an arbitration and management control 2230. Each engine can perform a read operations algorithm (e.g., RDSP algorithm). Each engine can be connected to memory (e.g., SRAM 2150) in order to get relevant parameters during RDSP operation process. Each engine can get a reg-file configuration (e.g., regfile CFG sets 2151) to define the exact algorithm.

In some embodiments, the SRAM 2150 can contain databases parameters. SRAM may include multiple instantiations of databases parameters that represents different algorithms. The SRAM can contains regfile configuration sets (e.g., regfile CFG sets 2151). The SRAM may include multiple instantiations of regfile configuration sets that represent different algorithms. The SRAM may be constructed from multiple physical cuts (e.g., cuts 501, 502, 503, 504) and/or an arbitration logic (e.g., memory arbiter 510), in order to provide high bandwidth according to engines processing bandwidth.

In some embodiments, each CPU (e.g., CPU 2110-0, 2110-1, 2110-2, 2110-3) can simultaneously configure its own per-CPU regfile independently. In some embodiments, a mem-regfile (e.g., mem-regfile 2123) can be loaded from SRAM once a task from specific CPU is selected (e.g., by arbitration and management control 2230), before RDSP operation is performed, according to a pointer in the per-CPU regfile (e.g., per-CPU regfile 2122-0).

In some embodiments, arbitration and management controls (e.g., arbitration and management control 2230) can be performed. A CPU (e.g., CPU 2110-0) can configure and/or activate a specific task through its per-CPU regfile (e.g., per-CPU regfile 2122-0). In some embodiments, an activation bit in regfile (not shown) can trigger the hardware and notify that a task configuration is ready for execution. RDSP-HW (e.g., controller 3320, arbitration and management control 2230) may select a ready task for execution according to one of the following options. As a first option, tasks may be scheduled in the order they arrive, using a First-Come-First-Served (FCFS) policy. For example, the system may configure short-tasks with higher priority in order to improve system performance. As a second option, tasks can be scheduled according to arrival order, and/or according to task priority (as configured in regfile). For example, system may configure specific tasks with a higher priority in order to precede its implementation on account of other tasks with a lower priority.

A top level of a hardware architecture according to some embodiments (e.g., RDSP HW) may be composed of several key components, including engines (e.g., K-means search engine 2125, R2R-LUT engine 2126, DNN engine 2127), SRAM 2150, per-CPU regfile, mem-regfile, and/or an arbitration and management control (e.g., arbitration and management control 2230). Each component can play a vital role in the operation of the RDSP-HW.

In some embodiments, each engine can be responsible for executing a specific RDSP algorithm. The engines can be connected to memory (e.g., SRAM 2150) to retrieve the necessary parameters during the RDSP operation process. The engines can receive regfile configurations that define the exact algorithm to be executed.

In some embodiments, SRAM (e.g., SRAM 2150) can store database parameters (and may include multiple instantiations, representing different algorithms for same engine). SRAM can store regfile configuration sets (e.g., regfile CFG sets 2151). The SRAM can store regfile configuration sets (and may include multiple instantiations, representing different algorithms for same engine).

In some embodiments, SRAM may be constructed from multiple physical cuts (e.g., cuts 501, 502, 503, 504), with accompanying arbitration logic (e.g., memory arbiter 510), to provide high bandwidth aligned with the engines' processing capabilities.

In some embodiments, each CPU (e.g., CPU 2110-0) can have the capability to independently and simultaneously configure its own per-CPU regfile (e.g., per-CPU regfile 2122-0). Each CPU can initiate and activate a specific task through its per-CPU regfile. An activation bit (not shown) within the per-CPU regfile can trigger the hardware, indicating that the task configuration is ready for execution.

In some embodiments, CPUs can monitor the completion of their tasks by polling their per-CPU regfile. Alternatively, an interrupt signal can be used to notify the CPU when the task is completed. Polling may be preferred for tasks with short latency, as polling can avoid the performance degradation that can occur due to context-switch overhead. Once a task is completed, the CPU can retrieve the task results from the status registers within the per-CPU regfile.

In some embodiments, the mem-regfile (e.g., mem-regfile 2123) can be a single configuration structure that is loaded from SRAM (e.g., SRAM 2150) when a task from a specific CPU is selected. This loading can occur before the RDSP operation is performed and is directed by a pointer in the per-CPU regfile. A flash memory system can perform an arbitration and management control (e.g., arbitration and management control 2230). Each CPU can configure and activate a specific task through its per-CPU regfile. An activation bit in the regfile can trigger the hardware, signaling that the task configuration is ready for execution.

In some embodiments, the RDSP-HW (e.g., read hardware engine 2120, arbitration and management control 2230) can select a ready task for execution based on the following options: (1) First-Come-First-Served (FCFS)-tasks can be scheduled in the order they arrive; for example, the system may assign a higher priority to shorter tasks to improve overall system performance; and (2) priority-based scheduling-tasks can be scheduled according to both their arrival order and priority, as configured in the per-CPU regfile; for example, the system may assign higher priority to specific tasks to ensure they are executed before other lower-priority tasks.

As shown in FIG. 22, an SRAM 2250 may include a first registration file configuration set 2251, a second registration file configuration set 2252, a first DNN(1) parameters 2254, and/or a second DNN(2) parameters 2256. A first CPU (CPU(1)) (e.g., CPU 2110-0) can configure a first DNN task (with the DNN(1) parameters 2254) in its per-CPU regfile, and a second CPU (CPU(2)) (e.g., CPU 2110-0) can configure a second DNN task (with the DNN(2) parameters 2256) in its per-CPU regfile. Assuming the task from CPU(1) is selected for execution, the pointer in its per-CPU regfile 2220 can direct the RDSP-HW to RegFileSet(1) 2251. The RDSP-HW can then copy the contents from RegFileSet(1) 2251 into the MemRegFile 2220. As a result, the MemRegFile registers can be configured with DNN pointers 2221, 2222, 2223 for weights, biases, and scaling parameters, specifically pointing to the DNN(1) parameters 2254. Once the DNN engine (e.g., DNN engine 2127) is activated, the DNN engine can access the DNN(1) parameters 2254 according to the configurations stored in the MemRegFile. Similarly, when task from CPU(2) is selected for execution RegFileSet(2) 2252 can be copied to mem-regfile 2220 and so on.

FIG. 23 is a diagram illustrating an example scheme 2300 of output mapping logic 2310, according to some embodiments. In some embodiments, after a task is completed, a CPU (e.g., CPU 2110-0) can retrieve the task results from the status registers within the per-CPU regfile. To minimize APB traffic (e.g., APB 2112) and reduce the overall RDSP operation latency (especially during R2R operations in SOL scenarios) this mapping logic 2310 can be particularly useful. FIG. 23 shows R2R Operations and threshold mapping. In some embodiments, R2R operations, whether performed through the DNN engine or the R2R-LUT engine, can generate read thresholds (e.g., TLC: TO-T6, QLC: TO-T14). Typically, each read threshold can be mapped to an individual status register. For example, each threshold from a CB 2301, LUT 2302, and/or DNN 2303 can be mapped to a corresponding status register in a perCPU regfile 2320 using the mapping logic 2310. However, in some systems, multiple read thresholds can be packed into a single status register, depending on the bit width. For example, if each read threshold is 8 bits wide and the status register is 32 bits wide and the mapping logic 2310 defines mapping layers (e.g., multiplexers) 2312-0, 2312-1, 2312-2, 2312-3, the R2R outputs can be mapped as follows: Status Register 0 (2322-0) holds RdThresholds[3]˜RdThresholds[0] using the mapping 2312-0; Status Register 1 (2322-1) holds RdThresholds[7]˜RdThresholds[4] using the mapping 2312-1; Status Register 2 (2322-2) holds RdThresholds[11]˜RdThresholds[8] using the mapping 2312-2; Status Register 3 (2322-3) holds RdThresholds[15]˜RdThresholds[12] using the mapping 2312-3.

In some embodiments, mapping can be performed as follows. Thresholds can be generated in an ascending order. For example, both DNN and R2R engines can generate read thresholds in a predefined ascending order (e.g., RdThresholds T1 to T15). The system may include a mapping layer such that a configurable mapping layer translates these thresholds before writing them to the output registers. This provides flexibility in the output format without affecting the internal engine operations. The system can perform output register multiplexing such that the mapping layer can allow for specific read thresholds to be multiplexed to specific output registers. The system can perform a regfile configuration such that the 16 first outputs from [CB/LUT/DNN] engines can be mapped to the corresponding 16 status register bits.

This mapping process can have the following benefits. First, the mapping can enable selective reading such that the CPU can map relevant outputs to a single or a few status registers, reducing the number of APB reads required. Second, the mapping can improve efficiency such that this approach can eliminate the need for firmware to process all read thresholds from all status registers, select only the required thresholds, and rearrange them in the necessary order.

For example, DNN-R2R per-page for a QLC device (15 thresholds, DNN with 15 outputs) can be configured as follows: (1) lower page: read thresholds T0, T2, T5, T11; (2) middle page: read thresholds T1, T7, T10, T12; (3) upper page: read thresholds T3, T9, T13; and (4) top page: read Thresholds T4, T6, T8, T14. In some embodiments, an effective mapping can be configured as follows: (1) lower page can map read thresholds T0, T2, T5, T11 to status register 0 (2322-0); (2) middle page can map read thresholds T1, T7, T10, T12 to status register 0; (3) upper page can map read thresholds T3, T9, T13 to status register 0; and (4) top page can map read thresholds T4, T6, T8, T14 to status register 0.

FIG. 24 is a diagram illustrating an example of clipping and DC offset adjustment 2400, according to some embodiments. A flash memory system can perform additional operations (e.g., clipping 2410 and/or DC offset adjustment 2420) on read thresholds. In some embodiments, an R2R operation, whether the R2R operation is LUT-based or DNN-based, can generate estimated read thresholds for the target row. In some cases, additional operations can be performed on these thresholds. Performing such additional operations in RDSP-HW can reduce the overall RDSP operation latency. On the other hand, if such additional operations are implemented in firmware, performing such additional operation may have an impact on controller read performance.

In some embodiments, the system can perform clipping 2410 as follows. For instance, in certain edge cases, the R2R algorithm may produce results outside the expected range, particularly when dealing with stresses that were not accounted for during offline training. To ensure valid outcomes, a clipping operation may be applied to the estimated thresholds. This ensures that the calculated read thresholds remain within predefined limits.

In firmware-based implementations, clipping each threshold can introduce latency. For example, in QLC devices, with up to 4 read thresholds per page, each threshold may need to be checked and clipped within a defined upper and lower bound, requiring multiple CPU operations. However, with the RDSP-HW architecture, all clipping checks can be performed simultaneously, completing the process within a single clock cycle. Following formula can describe read threshold clipping:

$$Thr [ k ] \_clipped = \{ \begin{matrix}engine\_thr [ k ] > max\_clip \_thr [ k ] & max\_clip \_thr [ k ] \\ engine\_thr [ k ] < min\_clip \_thr [ k ] & min\_clip \_thr [ k ] \\ else & engine\_thr [ k ]\end{matrix} \} \qquad ( Equation 10 )$$

When Thr[k]_clipped is a read threshold result from an R2R engine, and max_clip_thr[k], min_clip_thr[k] are parameters that are configured offline.

In some embodiments, the system can adjust DC Offsets 2420 that can be added to read-thresholds in real time. RDSP algorithms characterization can be done offline based on Vt-scans database that has been generated from representative flash devices. Due to various reasons, the VT-scan database may not exactly match to actual NAND devices in real time. The gap can be addressed by applying fixed offsets to thresholds that are used on actual flash devices to improve accuracy. However, in firmware-based implementations, such operation may require per-threshold add operation, while with an hardware architecture (e.g., RDSP-HW architecture), all DC offsets operations can be performed simultaneously within a single clock cycle.

Another example of an operation that can be applied in real time is the addition of a DC offset to the read thresholds. RDSP algorithms can be characterized offline based on Vt-scans derived from representative flash devices. However, due to various reasons (for example, variations in manufacturing) the actual Vt distribution in NAND devices may deviate from the original Vt-scan database used for algorithm development. This gap can be mitigated by applying fixed DC offsets to the read thresholds when working with real-time flash devices. In a firmware-based implementation, this operation would require adding a fixed offset to each threshold individually, which introduces latency, while with the RDSP-HW architecture, all DC offset adjustments can be applied to the thresholds simultaneously, within a single clock cycle.

In some embodiments, the system can provide a hardware architecture (e.g., RDSP-HW) that can operate with multiple CPUs. In typical memory controllers, random-read flows can present significant challenges for performance. Each random-read command can associate with a small data chunk (e.g., 4 KB) scattered across different die/block/pages, unlike sequential-read commands which generally involve larger chunks of data (e.g., 16 KB). For every 4 KB of data sent to the host, the controller needs to complete all associated management tasks (e.g., command parsing, logical-to-physical address translation). This may increase latency and may limit the throughput, especially in random reads.

To improve performance, a common solution can be to use multiple CPUs to distribute workload across different read commands. However, R2R operations, which estimate optimal read commands for a specific row, are often too time-sensitive to be efficiently handled in firmware (FW), especially during Start of Life (SOL), where system performance is critical. This is where a hardware architecture according to some embodiments (e.g., RDSP-HW block) excels, providing low-latency R2R operations to optimize read performance. A straightforward approach would be to attach an RDSP-HW block to each CPU, but this significantly increases gate count, memory footprint, and power consumption, as attaching the RDSP-HW block may require duplicating the RDSP-HW block for each CPU. This duplication may result in inefficiencies that are undesirable in complex system architectures.

A hardware architecture according to some embodiments can provide an optimized solution by allowing multiple CPUs to access a single RDSP-HW block simultaneously. Each CPU can interact with the RDSP-HW block as if each CPU were a distinct virtual machine, thanks to dedicated register file configuration spaces (e.g., per-CPU regfile). This design allows the RDSP-HW to manage and synchronize tasks originating from various CPUs, eliminating the need to replicate the RDSP-HW block for each CPU. In this manner, RDSP-HW throughput can be improved.

In some embodiments, the flowing setup can enable the RDSP-HW to maximize throughput by operating in a pipeline: while one task is being configured (mem-regfile configuration), another task can be executed on the engine (task execution). Meanwhile, the CPUs are free to interact with their respective per-CPU regfiles for configuration or status checking, allowing for continuous task management in the background.

In some embodiments, a pipeline workflow can be defined such that the RDSP-HW operates in two main pipeline steps: pipeline step (1) and pipeline step (2). In pipeline step (1), the system can configure a mem-regfile such that the RDSP-HW selects a task activated by a CPU, loads the mem-regfile from SRAM (based on the per-CPU regfile pointer), and samples the configuration for the next stage when it is available. In pipeline step (2) the system can perform a task execution such that the RDSP-HW activates the corresponding engine based on the sampled configuration and updates the status register with the engine's result once the task is complete.

An example system workflow is as follows. In step 1, each CPU can independently configure and activate its per-CPU regfile for a specific task. This can be done simultaneously by all CPUs. In step 2, the RDSP-HW can select a task according to the scheduling policy, load the required configuration into the mem-regfile, and begin executing the task on the engine. In step 3, while one task is being executed by the engine, other CPUs can continue to configure their per-CPU regfiles or check task completion in parallel.

FIG. 25 is a diagram illustrating an example system 2500 of pipeline hardware operating with multiple CPUs, according to some embodiments. FIG. 25 illustrates a system with three CPUs 2510-0, 2510-1, 2510-2 working with a single RDSP-HW block (e.g., HW engine 2530) and with a mem-regfile (e.g., mem-regfile 2520). In some embodiments, the system 2500 can perform a back-to-back task execution. For example, task executions on the RDSP engine can occur consecutively with a minimal delay. In some embodiments, the system 2500 can perform a background configuration and status checking. For example, CPU configuration (e.g., configuration 2501) and read-status operations (e.g., Done Rd Status 2502) can be performed in parallel, independently of the engine task execution. In some embodiments, the system can achieve an optimal CPU utilization. For example, CPU waiting time (e.g., a time from task configuration T₁ to completion T₂ as shown in FIG. 25) may be effectively used for other firmware tasks, enhancing overall system performance. In this manner, the hardware architecture according to some embodiments can significantly improve system efficiency, minimizes latency, and optimizes area and power usage by allowing multiple CPUs 2510-0, 2510-1, 2510-2 to share the same RDSP-HW block 2530, rather than duplicating the RDSP-HW block for each CPU. As shown in FIG. 25, in some embodiments, each CPU can perform its configuration independently and simultaneously (e.g., configuration 2551 by CPU-0 and configuration 2552 by CPU-1) while accessing and/or loading the mem-regfile sequentially (e.g., mem-regfile loading 2561 and mem-regfile loading 2562) and executing a task using the same hardware engine (e.g., RDSP-HW block) sequentially (e.g., task execution 2571 and task execution 2572).

In some embodiments, the hardware engines according to some embodiments can implement algorithms that are used in a read flow and a read-retry flow as described in the following sections.

In some embodiments, the engines according to some embodiments can perform an HT-GET operation based on an R2R operation. In some embodiments, upon every read command, the HT-Get operation can use the HT index to determine whether the reference row thresholds are default thresholds or retry-fixed thresholds-reads, or even post-QT thresholds. In some embodiments, per read command, the reference row thresholds in the target block can be extracted during the HT-Get operation, and then the system (e.g., firmware) can performs an R2R operation in order to compute the read thresholds for the target row using RDSP-HW, and the target row thresholds can be provided to the NAND read command in real-time. During SOL, the system read performance may require to perform R2R in a very short latency in order not to harm system read performance.

In some embodiments, the engines according to some embodiments can perform an HT-SET operation based on operations of QT, R2R (target to reference), and/or K-means search. In some embodiments, in case of HB decoding failure (on normal read and all shift table read retries), the system can apply a Quick Threshold tracking (QT) that performs thresholds tracking, and estimate optimal read-thresholds. In some embodiments, the QT can perform a few mock reads with fixed thresholds, from which a histogram is computed. The histogram can be used for estimating the current thresholds by an estimator. The estimator can be a linear estimator (using DNN with zero hidden layers) or a DNN based estimator. The current estimated thresholds can be configured to NAND for a retry read and HB decode.

In some embodiments, for future reads, the current estimated thresholds can be transferred by an R2R operation (e.g., LUT based R2R operation or DNN based R2R operation) to reference row thresholds, and the reference row thresholds can be used for updating the HT table. Performing HT-Set can compress the thresholds into an index pointer HTindex for the HT table. The HTindex can point to HT thresholds that are closest to the reference row thresholds that are associated with the estimated read thresholds, and can be used for subsequent reads from the same block. The process of finding the HTindex can be performed via exhaustive search using the K-means search engine. It is noted that without RDSP-HW engine according to some embodiments, HTindex search might be executed in non-exhaustive methods, like using binary search tree, by considering the latency for the search.

In some embodiments, the engines according to some embodiments can perform a read flow as follows. The HT-GET flow can be initiated by the controller (e.g., firmware) for each read command. In this HT-GET flow, the controller can provide the HT-Index associated with the target block, as well as the target row number. In return, the HT-GET flow can yield or return the estimated read thresholds for the specified target row.

FIG. 26 to FIG. 32 demonstrate several different flows usage with a hardware block (e.g., RDSP-HW (read digital signal processor hardware) block). In each figure, the active input, engines, and/or outputs are highlighted in bold faces and thick lines.

FIG. 26 is a diagram illustrating an example hardware implementations for HT-GET-DNN for a first-phase read operation, according to some embodiments. FIG. 26 depicts a general architecture of a hardware block (or hardware engine) 2600. The hardware block may include engines (e.g., one or more circuits or processors) for DNN 2610, R2R (estimator) 2620, or K-means search 2630. In some embodiments, such hardware block can be replaced or combined with software, firmware or a combination thereof. The hardware block also can include databases (e.g., one or more memories or storages 2640, 2650) for a codebook and/or R2R estimation which can be offline calculated and can be one-time initialized after power-up. In some embodiments, inputs to the hardware block may include (1) input features 2601, (2) a target row 2602, and/or (3) CB (codebook) index 2603 for use by a DNN 2610 and/or a R2R estimator 2620. The input features may include thresholds-In 2605 which may be used as input for a DNN 2610 when used, or used as input for a R2R estimator 2620 when used, or used as input for a K-means search 2630 when used. The input features may include additional inputs 2606 such as a set of rows, a cycle range, temperature(s) at programing and/or reading, etc. In some embodiments, outputs of the hardware block may include (1) estimated read thresholds 2607, and/or (2) CB index 2608 (e.g., CB index as output of a K-means search).

FIG. 26 shows a flow or a hardware block implementing or activating a R2R-DNN operation (or R2R-DNN engine 2600) for first-phase read. Inputs to the hardware block may include (in a per-CPU regfile) a CB index 2602 and/or a target row 2604. Outputs of the hardware block may include (in a per-CPU regfile) read thresholds 2651 for the target row. In some embodiments, a input layer of a DNN does not include read-thresholds as input features, and instead, the input read thresholds 2601 which are constant, can be embodied or included in other network parameters. In some embodiments, an input layer of a DNN may include additional parameters 2603 (for example, a cycle count, a row set, temperature(s) at programing and/or reading, etc.) arrived from a per-CPU regfile. The DNN 2611 can compute read thresholds 2611 of the target row 2604.

FIG. 27 is a diagram illustrating an example hardware implementations for HT-GET-DNN using HT-codebook (CB) index with R2R DNN for target row thresholds estimation, according to some embodiments. FIG. 27 shows a flow or a hardware block implementing or activating a HT-GET-DNN operation (or a HT-GET-DNN engine 2700). Inputs to the hardware block may include (in a per-CPU regfile) a CB index 2701 and/or a target row 2702. Outputs of the hardware block may include (in a per-CPU regfile) read thresholds 2751 for the target row 2702. In some embodiments, read-thresholds associated with the reference row can be read from a codebook 2640 according to the CB Index 2701. In some embodiments, an input layer of a DNN can include reference row read thresholds, and optionally additional parameters 2712 (for example, a cycle count, a row set (a set of rows), temperature(s) at programing and/or reading, etc.). The DNN 2610 can compute read thresholds 2713 of the target row 2702.

FIG. 28 is a diagram illustrating an example hardware implementations for HT-GET-LUT using HT-CB index with R2R look-up table (LUT), for target row thresholds estimation, according to some embodiments. FIG. 28 shows a flow or a hardware block implementing or activating a R2R-LUT based operation (or R2R-LUT engine 2800). Inputs to the hardware block may include (in a per-CPU regfile) a CB index 2801 and/or a target row 2802. In some embodiments, a reference row can be extracted from a codebook 2640. Outputs of the hardware block may include (in a per-CPU regfile) read thresholds 2851 for the target row 2602. In some embodiments, read thresholds associated with a reference row (e.g., reference row read thresholds) can be read from a codebook 2640 according to the CB Index 2801. In some embodiments, offsets from the reference row to the target row can be read or obtained from a R2R estimator 2620 according to the target row. In some embodiments, a R2R transformation can be performed based on the reference row read thresholds and the offsets.

The engines according to some embodiments can perform read-retry flows as follows. In some embodiments, read-retry flows can be performed after HB-decoding failure of all shift indices. In that case, the read thresholds for the failed-page can be estimated (e.g., by performing QT) and used to read the failed page. In addition, an HT-set operation can be performed, in which the system can transform the estimated thresholds of a target row to a common reference row. The system can then compress the common reference row by assigning the closest thresholds of HT table, and saving the corresponding HTIndex in the HT table.

FIG. 29 is a diagram illustrating an example hardware implementations for general DNN operations, according to some embodiments. FIG. 29 shows a flow or a hardware block implementing or activating a general DNN operation/engine 2900 (e.g., a DNN operation/engine that can be used for a QT-DNN operation). Various DNN operations can be implemented according to different DNN parameters. Inputs to the hardware block may include (in a per-CPU regfile) input features 2901, a network architecture, and/or network parameters. Outputs of the hardware block may include (in a per-CPU regfile) DNN outputs 2951. In some embodiments, the hardware block can execute or perform a QT-DNN operation (or QT-DNN engine) using inputs including (in a per-CPU regfile) QT Histograms 2902, and additional inputs 2903 such as a set of rows (row set), a cycle range (optional), and/or temperature(s) at programing and/or reading. Using the inputs, the QT-DNN engine can output (in a per-CPU regfile) QT read thresholds 2911.

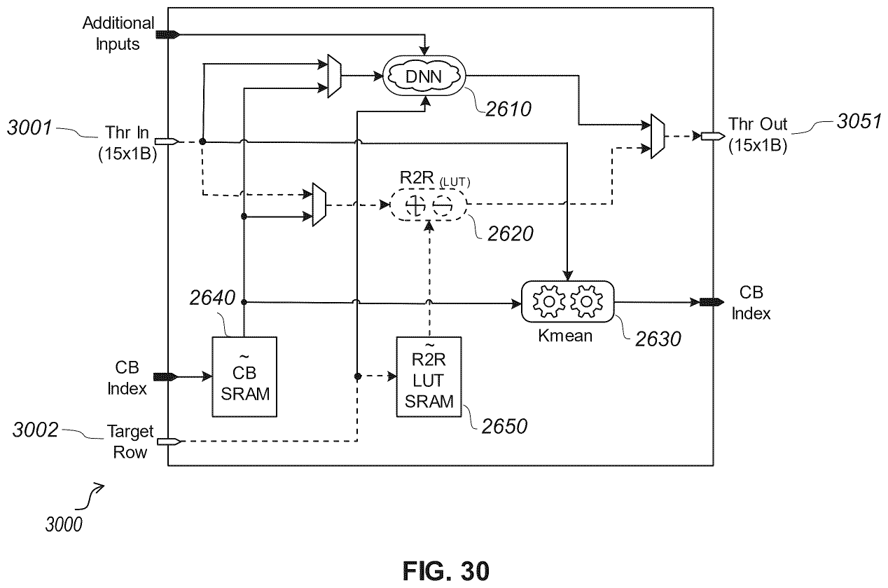

FIG. 30 is a diagram illustrating an example hardware implementations for R2R target-row to reference-row thresholds estimation using LUT, according to some embodiments. FIG. 30 shows a flow or a hardware block implementing or activating a target-row to reference-row operation (or a target-row to reference-row engine 3000). In some embodiments, the flow shown in FIG. 30 can activates a LUT engine 2620, 2650. Inputs to the hardware block may include (in a per-CPU regfile) target row thresholds 3001 and/or a target row 3002. Outputs of the hardware block may include (in a per-CPU regfile) reference row thresholds 3051. In some embodiments, offsets from the target row to a reference row can be read or obtained from a R2R estimator 2620 according to the target row. In some embodiments, a R2R transformation can be performed based on the target row thresholds and the offsets.

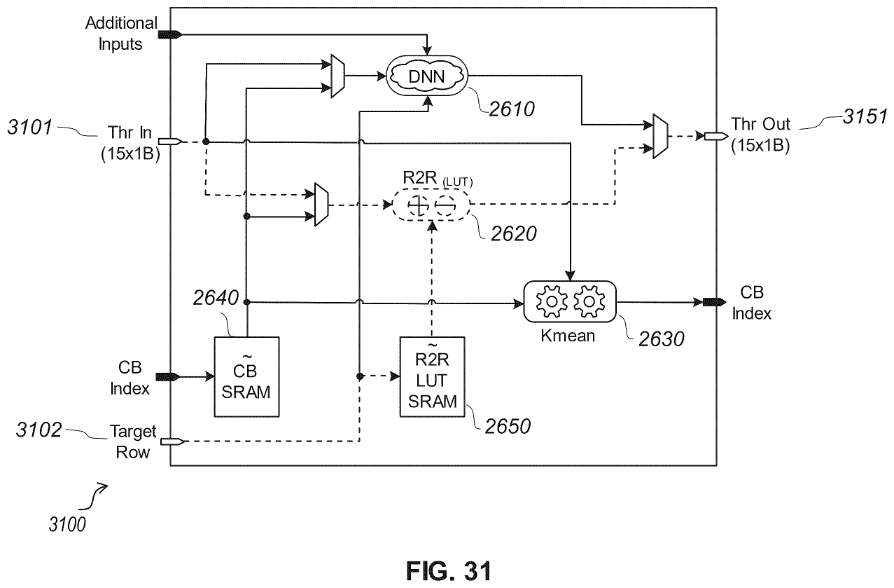

FIG. 31 is a diagram illustrating an example hardware implementations for R2R reference-row to target-Row thresholds estimation using LUT, according to some embodiments. FIG. 31 shows a flow or a hardware block implementing or activating a reference-row to target-row operation (or reference-row to target-row engine 3100). Inputs to the hardware block may include (in a per-CPU regfile) reference row thresholds 3101, a reference row, and/or a target row 3102. Outputs of the hardware block may include (in a per-CPU regfile) read thresholds 3151 for the target row 3102.

FIG. 32 is a diagram illustrating an example hardware implementations for HT-Set using a K-means search for computing a CB-index given input thresholds, according to some embodiments. FIG. 32 shows a flow or a hardware block implementing or activating a K-means search operation (or K-means search engine 3200). Inputs to the hardware block may include (in a per-CPU regfile) reference row thresholds 3201. Outputs of the hardware block may include a CB index 3251 (in a per-CPU regfile). In some embodiments, the K-means engine 2630 can compare the reference row thresholds to all clusters in a codebook 2640 and find the CB-index 3251 associated with a best match central-point entry.

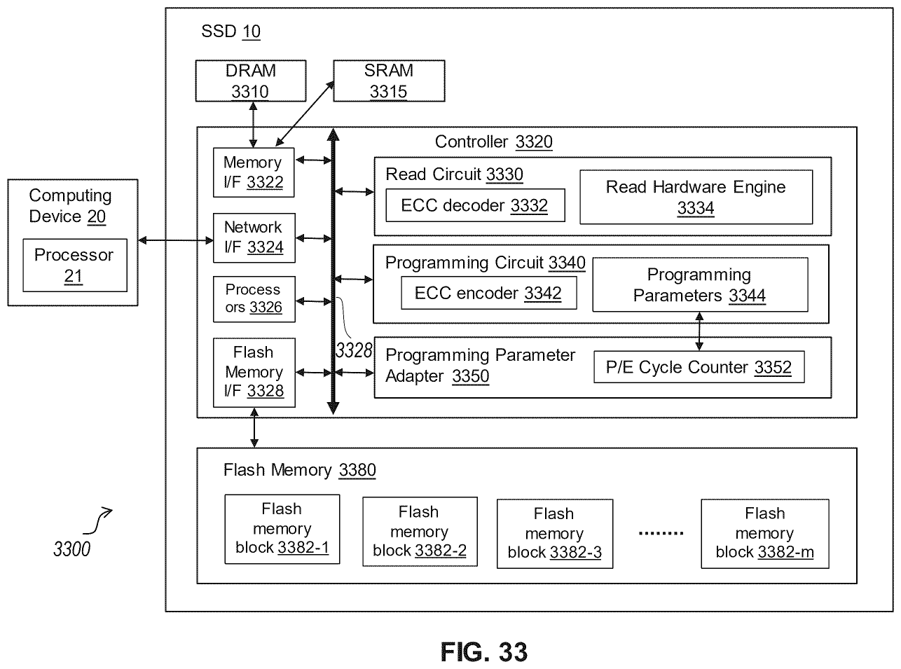

FIG. 33 is a block diagram illustrating an example flash memory system according to some arrangements.

Referring to FIG. 33, a flash memory system 3300 may include a computing device 20 and a solid-state drive (SSD) 10, which is a storage device and may be used as a main storage of an information processing apparatus (e.g., a host computer). The SSD 10 may be incorporated in the information processing apparatus or may be connected to the information processing apparatus via a cable or a network.

The computing device 20 may be an information processing apparatus (computing device). In some arrangements, the computer device 20 which is configured to handle or process data for training and perform a training a neural network (e.g., DNN 300), and the data for training may be collected from a plurality of SSDs by a plurality of computing devices. The data collected from the plurality of SSDs may be recorded and handled/processed by a different computing device, which is not necessarily connected to any of the SSDs and which performs the training based on the collected data. The computing device 20 includes a processor 21 and/or a database system 26. The database system 26 may store read thresholds values including training sets or results of a training.

The SSD 10 includes, for example, a controller 3320 and a flash memory 3380 as non-volatile memory (e.g., a NAND type flash memory). The SSD 10 may include a random access memory which is a volatile memory, for example, DRAM (Dynamic Random Access Memory) 3310 and/or SRAM (Static Random Access Memory) 3315. The random access memory has, for example, a read buffer which is a buffer area for temporarily storing data read out from the flash memory 3380, a write buffer which is a buffer area for temporarily storing data written in the flash memory 3380, and a buffer used for a garbage collection. In some arrangements, the controller 3320 may include DRAM or SRAM.

In some arrangements, the flash memory 3380 may include a memory cell array which includes a plurality of flash memory blocks (e.g., NAND blocks) 3382-1 to 3382-m. Each of the blocks 3382-1 to 3382-m may function as an erase unit. Each of the blocks 3382-1 to 3382-m includes a plurality of physical pages. In some arrangements, in the flash memory 3380, data reading and data writing are executed on a page basis, and data erasing is executed on a block basis.

In some arrangements, the controller 3320 may be a memory controller configured to control the flash memory 3380. The controller 3320 includes, for example, one or more processors (e.g., CPUs) 3326, a flash memory interface 3328, and a memory interface 3322, a network interface 3324, all of which may be interconnected via a bus 3328. The memory interface 3322 may include a DRAM controller configured to control an access to the DRAM 3310, and a SRAM controller configured to control an access to the SRAM 3315. The flash memory interface 3328 may function as a flash memory control circuit (e.g., NAND control circuit) configured to control the flash memory 3380 (e.g., NAND type flash memory). The network interface 3324 may function as a circuit which receives various data from the computing device 20 and transmits data to the computing device 20. The data may include a plurality of sets of read thresholds or other data collected from the flash memory 3380 or a plurality of SSDs for training a neural network (e.g., DNN 300).

The controller 3320 may include a read circuit 3330, a programming circuit (e.g. a program DSP) 3340, and/or a programming parameter adapter 3350. As shown in FIG. 33, the adapter 3350 can adapt the programming parameters 3344 used by programming circuit 3340 as described above. The adapter 3350 in this example may include a Program/Erase (P/E) cycle counter 3352. Although shown separately for ease of illustration, some or all of the adapter 3350 can be incorporated in the programming circuit 3340. In some arrangements, the read circuit 230 may include an ECC decoder 3332 and a read hardware engine 3334 (e.g., [TBD] system 500, system 600, RdDSP HW engine 820, DNN-based R2R estimator 900, hardware engine 1000). In some arrangements, the programming circuit 3340 may include an ECC encoder 3342. Arrangements of memory controller 3320 can include additional or fewer components such as those shown in FIG. 33.

In some embodiments, a flash memory system (e.g., SSD 10) may include a non-volatile memory (e.g., flash memory 3380), a controller (e.g., controller 3320) for performing operations on the non-volatile memory, and a plurality of processors (e.g., processors 2510-0, 2510-1, 2510-2) including a first processor (e.g., processor 2510-0) and a second processor (e.g., processor 2510-1). The non-volatile memory (e.g., flash memory 3380) may include one or more blocks (e.g., flash memory blocks 3382-1, 3382-2, . . . , 3382-m), each block comprising a plurality of rows of cells. The first processor (e.g., processor 2510-0) may generate a first configuration (e.g., configuration 2551) including a pointer to a first set of predefined configurations (e.g., regfile CFG sets 2151 in SRAM 2150) among a plurality of predefined configurations for performing read operations on the non-volatile memory. In response to generating the first configuration (e.g., configuration 2551), the controller may generate, in a memory (e.g., DRAM 3310), the first set of predefined configurations (e.g., mem-regfile loading 2561). The controller may execute a first operation (e.g., task execution 2571) according to the first set of predefined configurations generated in the memory. The second processor (e.g., processor 2510-1) may generate a second configuration (e.g., configuration 2552) comprising a pointer to a second set of predefined configurations (e.g., regfile CFG sets 2159 in SRAM 2150) among the plurality of predefined configurations. In response to generating the second configuration (e.g., configuration 2552), the controller may generate, in the memory, the second set of predefined configurations (e.g., mem-regfile loading 2562). The controller may execute a second operation (e.g., task execution 2572) according to the second set of predefined configurations generated in the memory.

In some embodiments, the first set of predefined configurations may be the same as the second set of predefined configurations. In some embodiments, the plurality of predefined configurations may correspond to a plurality of circuits for performing the read operations on the non-volatile memory. The first operation (e.g., R2R operation) may be executed using a first set of circuits (e.g., circuits in the R2R engine 2126) among the plurality of circuits. The second operation (e.g., DNN operation) may be executed using a second set of circuits (e.g., circuits in the DNN engine 2127) among the plurality of circuits. The second set of circuits may include at least one circuit that is not included in the first set of circuits.

In some embodiments, in executing the first operation, the controller may obtain a row identifier (e.g., target row 2702) identifying a row of a target page, among the plurality of rows. A machine learning model (e.g., DNN 2610) may generate one or more voltage thresholds (e.g., read thresholds 2713) for a read operation, based at least on the row identifier. The controller may perform the read operation on the target page of the non-volatile memory with the one or more voltage thresholds. The controller may obtain a shift index corresponding to a subset of one or more stress conditions and defining a shift to default voltage thresholds. The controller may generate a look-up table storing a plurality of voltage thresholds for each row. The controller may generate, using the look-up table, the one or more voltage thresholds, based on the shift index and the row identifier (e.g., using Equation 1 and Equation 2).

In some embodiments, in generating the one or more voltage thresholds, the controller may receive, as an input feature of the machine learning model, the shift index and the row identifier. In response to receiving the shift index and the row identifier, the machine learning model may output the one or more voltage thresholds (e.g., using Equation 3).

In some embodiments, in generating the one or more voltage thresholds, the controller may receive, as an input feature of the machine learning model, the shift index, the row identifier, and one or more voltage thresholds extracted from a history table. The history table may store a plurality of voltage thresholds per block that are historically used and result in a decode success, and the shift index is an index to the history table. In response to receiving the shift index, the row identifier and the one or more voltage thresholds, the machine learning model may output the one or more voltage thresholds (e.g., using Equation 3).

In some embodiments, in executing the first operation, the controller may perform a plurality of read operations with fixed voltage thresholds. The controller may generate a histogram (e.g., QT histograms 2902) based on a result of the plurality of read operations. The controller may generate, based on the histogram, a set of voltage thresholds for a read operation on the target page of the non-volatile memory.

In some embodiments, in executing the first operation, the controller may generate a voltage threshold value representing the set of voltage thresholds. The controller may store the voltage threshold value in a look-up table storing a plurality of voltage thresholds.

In some embodiments, in the first operation, the controller may perform a plurality of read operations with the one or more voltage threshold. The controller may generate a histogram (e.g., QT histograms 2902) based on a result of the plurality of read operations. The controller may generate, based on the histogram, a set of voltage thresholds for a read operation on the target page of the non-volatile memory.

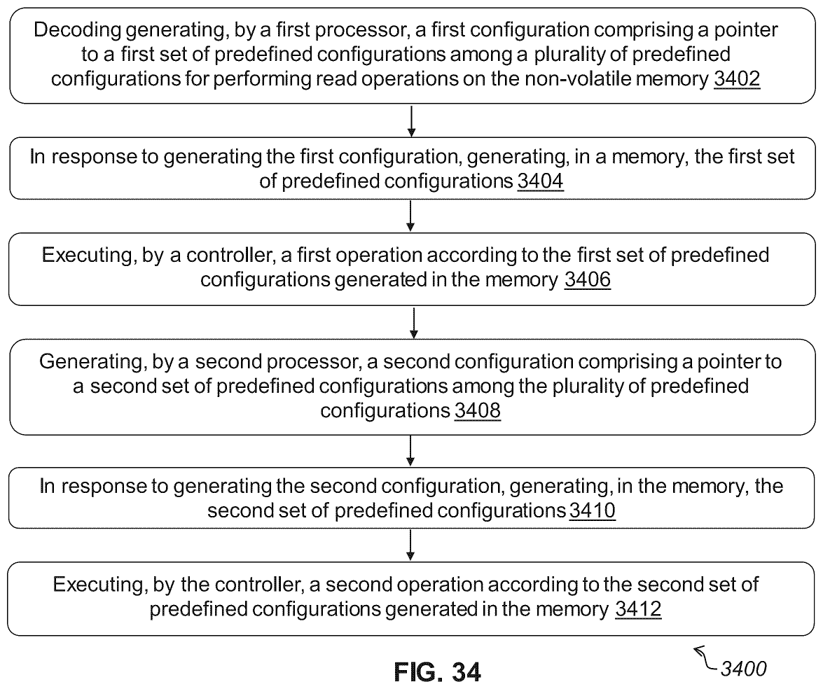

FIG. 34 is a flowchart illustrating an example methodology for providing configurable hardware blocks to perform read operations of a flash memory, according to some embodiments. In some arrangements, the example methodology relates to a process 3400 for performing operations on a non-volatile memory (e.g., flash memory 3380) including one or more blocks (e.g., flash memory blocks 3382-1, 3382-2, . . . , 3382-m), each block including a plurality of rows of cells. The process may be performed by one or more controllers (e.g., controller 3320) and/or one or more processors (e.g., processors 3326) of a flash memory system (e.g., NAND flash device, SSD10).

In this example, the process 3400 begins in step S3402 by generating, by a first processor (e.g., processor 2510-0), a first configuration (e.g., configuration 2551) including a pointer to a first set of predefined configurations (e.g., regfile CFG sets 2151) among a plurality of predefined configurations for performing read operations on the non-volatile memory.

In step S3404, in some embodiments, in response to generating the first configuration (e.g., processor 2510-0), the first set of predefined configurations may be generated (e.g., mem-regfile loading 2561) in a memory (e.g., DRAM 3310).

In step S3406, in some embodiments, a controller (e.g., controller 3320) may execute a first operation (e.g., task execution 2571) according to the first set of predefined configurations generated in the memory. In some embodiments, the plurality of predefined configurations may correspond to a plurality of circuits for performing the read operations on the non-volatile memory. The first operation (e.g., R2R operation) may be executed using a first set of circuits (e.g., circuits in the R2R engine 2126) among the plurality of circuits.

In step S3408, in some embodiments, a second processor (e.g., processor 2510-1) may generate a second configuration (e.g., configuration 2552) including a pointer to a second set of predefined configurations (e.g., regfile CFG sets 2159 in SRAM 2150) among the plurality of predefined configurations.

In step S3410, in some embodiments, in response to generating the second configuration (e.g., configuration 2552), the second set of predefined configurations may be generated in the memory (e.g., mem-regfile loading 2562). In some embodiments, the first set of predefined configurations may be the same as the second set of predefined configurations.

In step S3412, in some embodiments, the controller may execute a second operation (e.g., task execution 2572) according to the second set of predefined configurations generated in the memory. The second operation (e.g., DNN operation) may be executed using a second set of circuits among the plurality of circuits. The second set of circuits (e.g., circuits in the DNN engine 2127) may include at least one circuit that is not included in the first set of circuits.

In some embodiments, the first operation may include obtaining a row identifier (e.g., target row 2702) identifying a row of a target page, among the plurality of rows. A machine learning model (e.g., DNN 2610) may generate a one or more voltage thresholds (e.g., read thresholds 2713) for a read operation, based at least on the row identifier. The read operation on the target page of the non-volatile memory may be performed with the one or more voltage thresholds. A shift index corresponding to a subset of one or more stress conditions and defining a shift to default voltage thresholds may be obtained. The controller may generate a look-up table storing a plurality of voltage thresholds for each row. The one or more voltage thresholds may be generated using the look-up table, based on the shift index and the row identifier (e.g., using Equation 1 and Equation 2).

In some embodiments, in generating the one or more voltage thresholds, the shift index and the row identifier may be receiving, as an input feature of the machine learning model. In response to receiving the shift index and the row identifier, the machine learning model may output the one or more voltage thresholds (e.g., using Equation 3).

In some embodiments, in generating the one or more voltage thresholds, the shift index, the row identifier, and one or more voltage thresholds extracted from a history table may be received as an input feature of the machine learning model. The history table may store a plurality of voltage thresholds per block that are historically used and result in a decode success. The shift index may be an index to the history table. In response to receiving the shift index, the row identifier and the one or more voltage thresholds, the machine learning model may output the one or more voltage thresholds (e.g., using Equation 3).

In some embodiments, the first operation may include performing a plurality of read operations with fixed voltage thresholds. A histogram (e.g., QT histograms 2902) may be generated based on a result of the plurality of read operations. Based on the histogram, a set of voltage thresholds for a read operation on the target page of the non-volatile memory may be generated.

In some embodiments, the first operation may include generating a voltage threshold value representing the set of voltage thresholds. The voltage threshold value may be stored in a look-up table storing a plurality of voltage thresholds.

In some embodiments, the first operation may include performing a plurality of read operations with the one or more voltage threshold. A histogram (e.g., QT histograms 2902) may be generated based on a result of the plurality of read operations. Based on the histogram, a set of voltage thresholds for a read operation on the target page of the non-volatile memory may be generated.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A method for performing operations on a non-volatile memory comprising one or more blocks, each block comprising a plurality of rows of cells, the method comprising:
generating, by a first processor, a first configuration comprising a pointer to a first set of predefined configurations among a plurality of predefined configurations for performing read operations on the non-volatile memory;
in response to generating the first configuration, generating, in a memory, the first set of predefined configurations;
executing, by a controller, a first operation according to the first set of predefined configurations generated in the memory;
generating, by a second processor, a second configuration comprising a pointer to a second set of predefined configurations among the plurality of predefined configurations;
in response to generating the second configuration, generating, in the memory, the second set of predefined configurations; and
executing, by the controller, a second operation according to the second set of predefined configurations generated in the memory.

2. The method of claim 1, wherein
the first set of predefined configurations is the same as the second set of predefined configurations.

3. The method of claim 1, wherein
the plurality of predefined configurations correspond to a plurality of circuits for performing the read operations on the non-volatile memory,
the first operation is executed using a first set of circuits among the plurality of circuits,
the second operation is executed using a second set of circuits among the plurality of circuits, and
the second set of circuits comprises at least one circuit that is not included in the first set of circuits.

4. The method of claim 1, wherein the first operation comprises:
obtaining a row identifier identifying a row of a target page, among the plurality of rows;
generating, by a machine learning model, one or more voltage thresholds for a read operation, based at least on the row identifier; and
performing the read operation on the target page of the non-volatile memory with the one or more voltage thresholds.

5. The method of claim 4, further comprising:
obtaining a shift index corresponding to a subset of one or more stress conditions and defining a shift to default voltage thresholds;
generating, by the machine learning model, a look-up table storing a plurality of voltage thresholds for each row; and
generating, using the look-up table, the one or more voltage thresholds, based on the shift index and the row identifier.

6. The method of claim 4, wherein generating the one or more voltage thresholds comprises:
receiving, as an input feature of the machine learning model, the shift index and the row identifier; and
in response to receiving the shift index and the row identifier, outputting, by the machine learning model, the one or more voltage thresholds.

7. The method of claim 4, wherein generating the one or more voltage thresholds comprises:
receiving, as an input feature of the machine learning model, the shift index, the row identifier, and one or more voltage thresholds extracted from a history table, wherein
the history table stores a plurality of voltage thresholds per block that are historically used and result in a decode success, and the shift index is an index to the history table; and
in response to receiving the shift index, the row identifier and the one or more voltage thresholds, outputting, by the machine learning model, the one or more voltage thresholds.

8. The method of claim 4, wherein the first operation comprises:
performing a plurality of read operations with fixed voltage thresholds;
generating a histogram based on a result of the plurality of read operations; and
generating, based on the histogram, a set of voltage thresholds for a read operation on the target page of the non-volatile memory.

9. The method of claim 8, wherein the first operation comprises:
generating a voltage threshold value representing the set of voltage thresholds; and
storing the voltage threshold value in a look-up table storing a plurality of voltage thresholds.

10. The method of claim 4, wherein the first operation comprises:
performing a plurality of read operations with the one or more voltage threshold;
generating a histogram based on a result of the plurality of read operations; and
generating, based on the histogram, a set of voltage thresholds for a read operation on the target page of the non-volatile memory.

11. A flash memory system comprising:
a non-volatile memory comprising one or more blocks, each block comprising a plurality of rows of cells;
a controller for performing operations on the non-volatile memory; and
a plurality of processors including a first processor and a second processor, wherein
the first processor generates a first configuration comprising a pointer to a first set of predefined configurations among a plurality of predefined configurations for performing read operations on the non-volatile memory,
in response to generating the first configuration, the controller generates, in a memory, the first set of predefined configurations,
the controller executes a first operation according to the first set of predefined configurations generated in the memory,
the second processor generates a second configuration comprising a pointer to a second set of predefined configurations among the plurality of predefined configurations,
in response to generating the second configuration, the controller generates, in the memory, the second set of predefined configurations; and
the controller executes a second operation according to the second set of predefined configurations generated in the memory.

12. The system of claim 11, wherein
the first set of predefined configurations is the same as the second set of predefined configurations.

13. The system of claim 11, wherein
the plurality of predefined configurations correspond to a plurality of circuits for performing the read operations on the non-volatile memory,
the first operation is executed using a first set of circuits among the plurality of circuits,
the second operation is executed using a second set of circuits among the plurality of circuits, and
the second set of circuits comprises at least one circuit that is not included in the first set of circuits.

14. The system of claim 11, wherein the first operation comprises:
obtaining a row identifier identifying a row of a target page, among the plurality of rows;
generating, by a machine learning model, one or more voltage thresholds for a read operation, based at least on the row identifier; and
performing the read operation on the target page of the non-volatile memory with the one or more voltage thresholds.

15. The system of claim 14, further comprising:
obtaining a shift index corresponding to a subset of one or more stress conditions and defining a shift to default voltage thresholds;
generating, by the controller, a look-up table storing a plurality of voltage thresholds for each row; and
generating, using the look-up table, the one or more voltage thresholds, based on the shift index and the row identifier.

16. The system of claim 14, wherein generating the one or more voltage thresholds comprises:
receiving, as an input feature of the machine learning model, the shift index and the row identifier; and
in response to receiving the shift index and the row identifier, outputting, by the machine learning model, the one or more voltage thresholds.

17. The system of claim 14, wherein generating the one or more voltage thresholds comprises:
receiving, as an input feature of the machine learning model, the shift index, the row identifier, and one or more voltage thresholds extracted from a history table, wherein
the history table stores a plurality of voltage thresholds per block that are historically used and result in a decode success, and the shift index is an index to the history table; and
in response to receiving the shift index, the row identifier and the one or more voltage thresholds, outputting, by the machine learning model, the one or more voltage thresholds.

18. The system of claim 14, wherein the first operation comprises:
performing a plurality of read operations with fixed voltage thresholds;
generating a histogram based on a result of the plurality of read operations; and
generating, based on the histogram, a set of voltage thresholds for a read operation on the target page of the non-volatile memory.

19. The system of claim 18, wherein the first operation comprises:
generating a voltage threshold value representing the set of voltage thresholds; and
storing the voltage threshold value in a look-up table storing a plurality of voltage thresholds.

20. The system of claim 14, wherein the first operation comprises:
performing a plurality of read operations with the one or more voltage threshold;
generating a histogram based on a result of the plurality of read operations; and
generating, based on the histogram, a set of voltage thresholds for a read operation on the target page of the non-volatile memory.
